(19) United States
(12) Patent Application Publication
(10) Pub. No.: US 2019/0095192 A1
(43) Pub. Date: Mar. 28, 2019

(54) INFORMATION PROCESSING APPARATUS AND FIRMWARE UPDATE METHOD

(71) Applicant: Konica Minolta, Inc., Tokyo (JP)

(72) Inventors: Katsuhiko Akita, Amagasaki-shi (JP); Yuji Okamoto, Amagasaki-shi (JP); Kazumi Sawayanagi, Itami-shi (JP); Masami Yamada, Osaka (JP); Atsushi Tamura, Amagasaki-shi (JP); Yasutaka Ito, Amagasaki-shi (JP)

(73) Assignee: Konica Minolta, Inc., Tokyo (JP)

(21) Appl. No.: 16/138,505

(22) Filed: Sep. 21, 2018

(30) Foreign Application Priority Data
Sep. 22, 2017 (JP) 2017-182415

(51) Int. Cl. G06F 8/65; G06F 3/12

(52) U.S. Cl. CPC G06F 8/65; G06F 3/1287; G06F 3/1204; G06F 3/123

(57) ABSTRACT

An information processing apparatus includes a hardware processor. The hardware processor executes an firmware of a first version, acquires a set of firmware of a second version and verification state information that indicates progress of verification of each of a plurality of processes defined by the firmware of the second version from a server, and updates the firmware of the first version with the firmware of the second version. The verification state information includes a completed state where the verification of a non-occurrence of an error is completed and an unverified state where the verification of the non-occurrence of an error is not completed, and the hardware professor sets a settability state of an unverified process out of the plurality of processes to a disabled state where a user cannot make settings to allow execution of the unverified process.

### CROSS-REFERENCE TO RELATED APPLICATIONS

Japanese Patent Application No. 2017-182415 filed on Sep. 22, 2017, is incorporated herein by reference in its entirety.

### BACKGROUND

### Technological Field

The present invention relates to an information processing apparatus and a firmware update method. More specifically, the present invention relates to an information processing apparatus in which a firmware is updated with firmware that has not been verified that an error does not occur during execution of a process, and a firmware update method performed in the information processing apparatus.

### Description of the Related art

Firmware is installed in an image forming apparatus represented by a conventional Multi Peripheral Function, and the image forming apparatus operates by execution of firmware by a central processing unit. Therefore, in the case where (i.e., when) the firmware is upgraded, the image forming apparatus is required to download the firmware of the new version and install the firmware therein.

For example, the Japanese Patent Application Laid-Open No. 2009-187377 discloses an image forming apparatus that is characterized in comprising a storing means for storing a plurality of software files, an execution means for executing functions provided by the image forming apparatus using the software files stored in the storage means, a receiving means for receiving an update software file for updating at least one software file out of the plurality of software files stored in the storage means from an information processing apparatus, and a control means for controlling to check the function to be executed in the case where the software file is updated based on the update software file received by the receiving means, and then a function using the updated software file is executed.

On the other hand, in the case where the firmware of a new version is developed, the firmware of the new version becomes available generally after completion of verification of normal functionality without an occurrence of an error in all of a plurality of processes defined by the firmware of the new version. Since a predetermined period of time is required for this verification, in the case where the verification has not finished for part of processes, the firmware cannot become available regardless of the completion of verification for the other processes. Thus, even in the case where the user attempts to execute only verified processes, the new firmware cannot be installed unless the verification is completed for all of the plurality of processes defined by the firmware of the new version.

### SUMMARY

According to one or more embodiments of the present invention, an information processing apparatus includes a hardware processor, the hardware processor executing an installed firmware of a first version, acquiring a set of firmware of a second version that is newer than the first version and verification state information indicating progress of verification of each of a plurality of processes defined by the firmware of the second version from a server, and updating the firmware of the first version with the firmware of the second version, wherein the verification state information indicates progress of verification that an error does not occur during execution of each of the plurality of processes, and includes a completed state where the verification of a non-occurrence of an error is completed and an unverified state where the verification of the non-occurrence of an error is not completed, and the hardware processor further sets a settability state of an unverified process, the verification state information of which indicates the unverified state, out of the plurality of processes, to a disabled state where a user cannot make settings to allow execution of the unverified process.

According to one or more embodiments of the present invention, an information processing apparatus includes a hardware processor, the hardware processor executing an installed firmware of a first version, storing history of execution of execution processes, acquiring a set of firmware of a second version that is newer than the first version and verification state information indicating progress of verification for each of a plurality of processes defined by the firmware of the second version from a server, and installing the firmware of the second version in order to update the firmware of the first version with the firmware of the second version, wherein the verification state information indicates progress of verification that an error does not occur during execution of each of the plurality of processes, and includes a completed state where the verification is completed and an unverified state where the verification is not completed, and the unverified state includes an error state where an occurrence of an error is confirmed, and the hardware processor further prohibits installation of the firmware of the second version in the case where the verification state information that makes a set with the firmware of the second version indicates the error state for an execution process specified by the history.

According to one or more embodiments of the present invention, a firmware update method includes executing an installed firmware of a first version, acquiring a set of firmware of a second version that is newer than the first version and verification state information indicating progress of verification of each of a plurality of processes defined by the firmware of the second version from a server, and updating the firmware of the first version with the firmware of the second version, wherein the verification state information indicates progress of verification that an error does not occur during execution of each of the plurality of processes, and includes a completed state where the verification of a non-occurrence of an error is completed and an unverified state where the verification of the non-occurrence of an error is not completed, and the firmware update method further includes setting a settability state of an unverified process, the verification state information of which indicates the unverified state, out of the plurality of processes to a disabled state where a user cannot make settings to allow execution of the unverified process.

According to one or more embodiments of the present invention, a firmware update method includes executing an installed firmware of a first version, storing history of execution of execution processes, acquiring a set of firmware of a second version that is newer than the first version and verification state information indicating progress of verification for each of a plurality of processes defined by the firmware of the second version from a server, and installing the firmware of the second version in order to update the firmware of the first version with the firmware of the second version, wherein the verification state information indicates progress of verification that an error does not occur during execution of each of the plurality of processes, and includes a completed state where the verification is completed and an unverified state where the verification is not completed, and the unverified state includes an error state where an occurrence of an error is confirmed, and the firmware update method further includes prohibiting installation of the firmware of the second version in the case where the verification state information that makes a set with the firmware of the second version indicates the error state for an execution process specified by the history.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing one example of an overview of an information processing system in one or more embodiments of the present invention;

FIG. 2 is a block diagram showing one example of an outline of a hardware configuration of a server in one or more embodiments of the present embodiment;

FIG. 3 is a block diagram showing one example of an outline of a hardware configuration of an MFP in one or more embodiments of the present embodiment;

FIG. 4 is a block diagram showing one example of functions of a CPU included in the MFP in one or more embodiments of the present invention;

FIG. 5 is a flow chart showing one example of a flow of a firmware update process in one or more embodiments of the present invention;

FIG. 6 is a flow chart showing one example of a flow of a group setting process;

FIG. 7 is a flow chart showing one example of a flow of an operation acceptance process in one or more embodiments of the present invention;

FIG. 8 is a diagram showing one example of verification state information corresponding to firmware of a second version;

FIG. 9 is a diagram showing one example of settability states;

FIG. 10 is a diagram showing one example of a settability state setting screen with firmware of a first version installed;

FIG. 11 is a first diagram showing one example of a settability state setting screen with firmware of a second version installed;

FIG. 12 is a second diagram showing one example of the settability state setting screen with the firmware of the second version installed;

FIG. 13 is a third diagram showing one example of the settability state setting screen with the firmware of the second version installed;

FIG. 14 is a diagram showing one example of a setting screen;

FIG. 15 is a diagram showing one example of verification state information corresponding to firmware of a third version;

FIG. 16 is a diagram showing one example of history information;

FIG. 17 is a diagram showing one example of priority order;

FIG. 18 is a block diagram showing one example of an outline of functions of a CPU of an MFP in a modified example of one or more embodiments of the present invention;

FIG. 19 is a flow chart showing one example of a flow of a firmware update process in the first modified example;

FIG. 20 is a flow chart showing one example of a flow of an operation acceptance process in the first modified example;

FIG. 21 is a block diagram showing one example of an outline of functions of a CPU of an MFP in one or more embodiments of the present invention;

FIG. 22 is a flow chart showing one example of a flow of a firmware update process in one or more embodiments of the present invention;

FIG. 23 is a flow chart showing one example of a flow of an update determination process, and

FIG. 24 is a block diagram showing one example of an outline of functions of a CPU of an MFP in a third modified example.

### DETAILED DESCRIPTION

Hereinafter, embodiments of the present invention will be described with reference to the drawings. However, the scope of the invention is not limited to the disclosed embodiments.

Embodiments of the present invention will be described below with reference to the drawings. In the following description, the same parts are denoted with the same reference characters. Their names and functions are also the same. Therefore, a detailed description thereof will not be repeated.

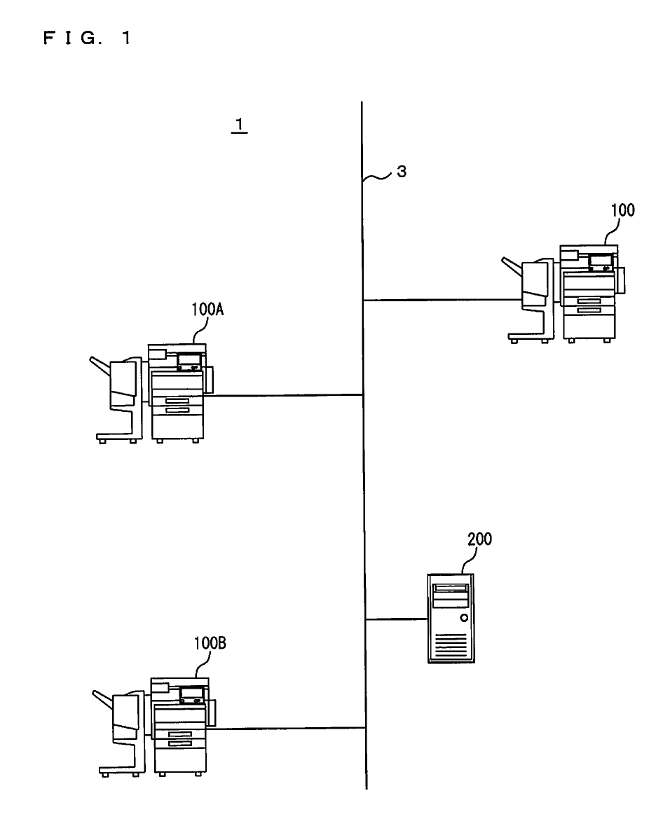

FIG. 1 is a diagram showing one example of an overview of an information processing system in one or more embodiments of the present invention. Referring to FIG. 1, the information processing system 1 includes MFPs (Multi Function Peripherals) 100, 100A, 100B and a server 200.

The MFPs 100, 100A, 100B are one example of an information processing apparatus and includes at least an image forming function for forming an image on a recording medium such as a sheet (a sheet of paper) based on image data. In addition to the image forming function, the MFPs 100, 100A, 100B may include a document scanning function of scanning a document and a facsimile transmission reception function of transmitting and receiving facsimile data. The server 200 is a general computer.

The server 200 and the MFPs 100, 100A, 100B are respectively connected to a network 3. The network 3 is a Local Area Network (LAN), either wired or wireless. The network 3 may further be connected to the Internet. In this case, the server 200 and the MFPs 100, 100A, 100B are respectively communicable with a computer connected to the Internet via the network 3. Further, the network 3 is not limited to the LAN and may be a network using Public Switched Telephone Networks. Further, the network 3 may be a Wide Area Network (WAN) such as the Internet.

In one or more embodiments of the present invention, the server 200 manages firmware installed in the MFPs 100, 100A, 100B. Specifically, the server 200 stores the firmware installed in the MFPs 100, 100A, 100B, and transmits the firmware of the requested version in response to a request from the MFPs 100, 100A, 100B. Each of the MFPs 100, 100A, 100B manages the version of the firmware installed therein. For example, the MFP 100 determines whether the firmware of the version newer than the version of the firmware installed therein is available from the server 200 by making an inquiry to the server 200 about the newest version of the firmware. For example, in the case where the server 200 makes the firmware of a second version that is newer than the first version available with the firmware of the first version installed in the MFP 100, the MFP 100 requests the transmission of the firmware of the second version to the server 200. In response to the request from the MFP 100, the server 200 transmits the firmware of the second version to the MFP 100. Thus, the MFP 100 installs the firmware of the second version transmitted from the server 200.

Further, the firmware of the second version stored in the server 200 may be associated with verification state information. The verification state information is the information that indicates a verification state indicating the progress of verification of a non-occurrence of an error during execution of each of a plurality of processes defined by the firmware of the second version. The verification state includes a completed state where the verification is completed, and an unverified state where the verification is not completed. Further, the unverified state includes an error state where the occurrence of an error is confirmed, and an unconfirmed state where the occurrence of an error is not confirmed. In the case where the MFP 100 requests the firmware of the second version to the server 200, when the verification state information is associated with the firmware of the second version, the server 200 transmits the verification state information to the MFP 100 together with the firmware of the second version.

Further, the server 200 provides a predetermined service to each of the MFPs 100, 100A, 100B. The server 200 provides services in response to requests from the MFPs 100, 100A, 100B by executing an application program for providing services. Although the services provided by the server 200 are not limited, the services include a character recognition process of extracting characters from an image based on image data, a translation process of converting the character data in one language into the character data in another language and a format conversion process of converting the format of data. Here, the application program executed by the server 200 in order for the server 200 to provide the services is referred to as a service provision program. In the case where the service provision program is upgraded when a new function is added, etc., the non-occurrence of an error may be verified or may not be verified for each of a plurality of processes defined by the upgraded service provision program. In this case, the server 200 provides server verification state information. The server verification state information is the information indicating the server verification state that includes the completed state where the verification is completed, and the unverified state where the verification is not completed, for each of the plurality of processes defined by the service provision program. Further, the unverified state includes the error state where the occurrence of an error is confirmed, and the unconfirmed state where the occurrence of an error is not confirmed.

In each of the MFPs 100, 100A, 100B, an application program for receiving services from the server 200 is installed. Here, the application program for receiving the services provided by the server 200 is referred to as a service instruction program. Each of the MFPs 100, 100A, 100B allows the server 200 to provide the services by executing the service instruction program, and receives the services from the server 200.

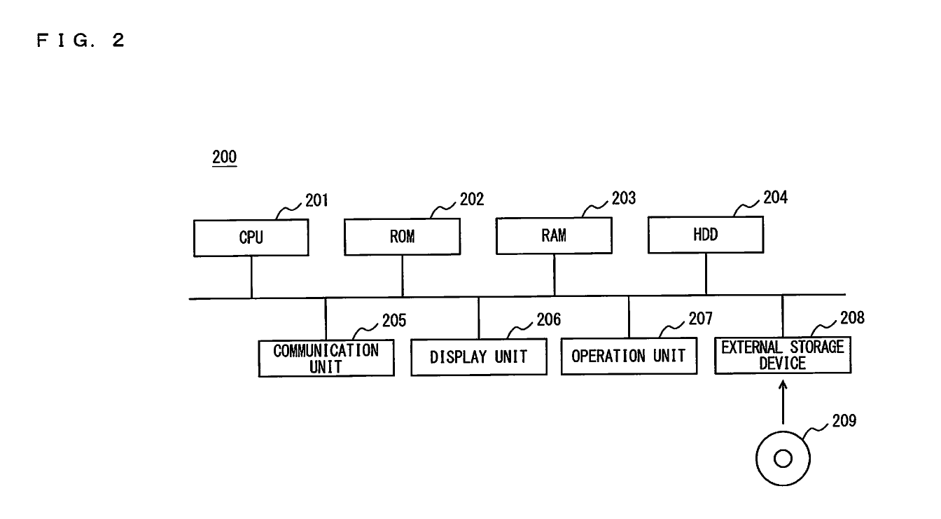

FIG. 2 is a block diagram showing one example of an outline of a hardware configuration of the server in one or more embodiments of the present invention. Referring to FIG. 2, the server 200 includes a Central Processing Unit (CPU) 201 for controlling the server 200 as a whole, a ROM (Read Only Memory) 202 for storing a program to be executed by a CPU 201, a RAM (Read Access Memory) 203 used as a work area of the CPU 201, a Hard Disc Drive (HDD) 204 for storing data in a non-volatile manner, a communication unit 205 for connecting the CPU 201 to the network 3, a display unit 206 for displaying information, an operation unit 207 for accepting a user input operation and an external storage device 208.

The display unit 206 is a display device such as a Liquid Crystal Display (LCD) device and an organic ELD (Electro-Luminescence Display). The operation unit 207 is hard keys such as a keyboard. Further, the operation unit 207 may be a touch panel. The touch panel is superimposed on an upper surface or a lower surface of the display unit 206. The touch panel detects the position designated by the user in a display surface of the display unit 206.

The communication unit 205 is an interface for connecting the CPU 201 to the network 3. The communication unit 205 communicates with the MFPs 100, 100A, 100B connected to the network using a communication protocol such as a TCP (Transmission Control Protocol) or a UDP (User Datagram Protocol). The protocol for communication is not limited in particular, and any protocol can be used. When IP (Internet Protocol) addresses of the respective MFPs 100, 100A, 100B are registered in the server 200, the server 200 can communicate with the respective MFPs 100, 100A, 100B and can transmit and receive data.

The HDD 204 stores the program executed by the CPU 201 and the data necessary for the execution of the program. The CPU 201 loads the program recorded in the HDD 204 into the RAM 203 for execution.

The external storage device 208 is mounted with a CD-ROM (Compact Disc ROM) 209 storing a program. The CPU 201 is capable of accessing the CD-ROM 209 via the external storage device 208. The CPU 201 loads the program, recorded in the CD-ROM 209 which is mounted on the external storage device 208, into the RAM 203 for execution. It is noted that the medium for storing the program executed by the CPU 201 is not limited to the CD-ROM 209. It may be an optical disc (MO (Magnetic Optical Disc)/MD (Mini Disc)/DVD (Digital Versatile Disc)), an IC card, an optical card, and a semiconductor memory such as a mask ROM or an EPROM (Erasable Programmable ROM).

Further, the program executed by the CPU 201 is not limited to a program recorded in the CD-ROM 209, and the CPU 201 may load a program, stored in the HDD 204, into RAM 203 for execution. In this case, another computer connected to the network 3 may rewrite the program stored in the HDD 204, or may additionally write a new program therein. Further, the server 200 may download a program from another computer connected to the network 3 or the Internet, and store the program in the HDD 204. The program referred to here includes not only a program directly executable by the CPU 201 but also a source program, a compressed program, an encrypted program or the like.

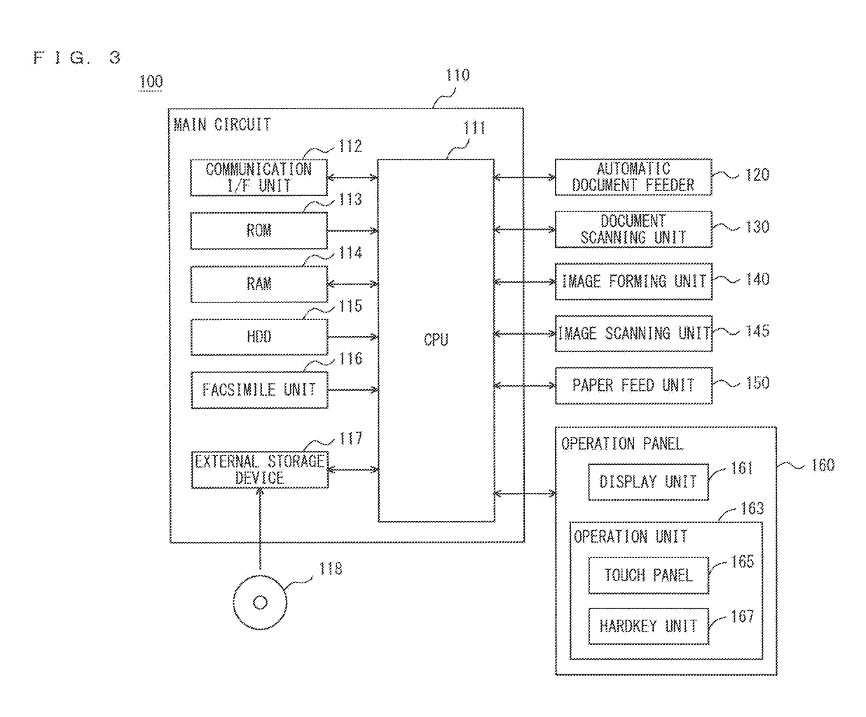

Since the hardware configuration and functions of the MFPs 100, 100A, 100B are the same, the MFP 100 is described here as an example. FIG. 3 is a block diagram showing one example of the outline of the hardware configuration of the MFP in one or more embodiments of the present invention. Referring to FIG. 3, the MFP 100 includes a main circuit 111, a document scanning unit 130 for scanning a document, an automatic document feeder 120 for conveying a document to the document scanning unit 130, an image forming unit 140 for forming an image on a sheet or other medium based on image data output by the document scanning unit 130 that has scanned a document, a paper feed unit 150 for supplying sheets to the image forming unit 140 and an operation panel 160 serving as a user interface.

The automatic document feeder 120 automatically transports a plurality of documents set on a document feed tray to a predetermined document scanning position set on a platen glass of the document scanning unit 130 one by one, and discharges the document, the image of which has been scanned by the document scanning unit 130, onto a document discharge tray. The document scanning unit 130 includes a light source that irradiates the document that has been transported to the document scanning position with light, and an optoelectronic transducer that receives the light reflected by the document and scans the document image according to a size of the document. The optoelectronic transducer converts the received light into image data, which is an electric signal, and outputs the image data to the image forming unit 140. The paper feed unit 150 conveys sheets stored in the paper feed tray to the image forming unit 140.

The image forming unit 140 forms an image by a well-known electrophotographic method. The image forming unit 140 forms an image on the sheet that has been conveyed by the paper feed unit 150, based on the processed image data obtained when various data processing such as shading correction is performed on the image data received from the document scanning unit 130 or the externally received image data, and discharges the sheet having an image formed thereon to the discharge tray.

The main circuit 110 includes a CPU (Central Processing Unit) 111 that controls the MFP 100 as a whole, a communication interface (I/F) unit 112, a ROM 113, a RAM 114, a Hard Disc Drive (HDD) 115 used as a mass storage device, a facsimile unit 116 and an external storage device 117. The CPU 111 is connected to the automatic document feeder 120, a document scanning unit 130, an image forming unit 140, a paper feed unit 150 and an operation panel 160, and controls the MFP 100 as a whole.

The facsimile unit 116 is connected to the Public Switched Telephone Networks (PSTN), and transmits facsimile data to and receives facsimile data from the PSTN. The facsimile unit 116 stores the received facsimile data in the HDD 115, converts the facsimile data into print data that can be printed by the image forming unit 140, and outputs the print data to the image forming unit 140. Thus, the image forming unit 140 forms an image on a sheet based on the facsimile data received from the facsimile unit 116. Further, the facsimile unit 116 converts the data stored in the HDD 115 into facsimile data, and transmits the facsimile data to the facsimile machine connected to the PSTN.

The communication I/F unit 112 is an interface for connecting the MFP 100 to the network 3. The communication I/F unit 112 communicates with the server 200 or other MFPs 100A, 100B connected to the network 3 using a communication protocol such as a TCP (Transmission Control Protocol) or an FTP (File Transfer Protocol).

The ROM 113 stores a program executed by the CPU 111 or data required for the execution of the program. The RAM 114 is used as a work area for the execution of the program by the CPU 111. Further, the RAM 114 temporarily stores scanned images successively transmitted from the document scanning unit 130.

The operation panel 160 is provided on an upper surface of the MFP 100. The operation panel 160 includes a display unit 161 and an operation unit 163. The display unit 161 is a Liquid Crystal Display (LCD) device, for example, and displays instruction menus to users, information about the acquired image data, and the like. When the display unit 161 is a device that displays images instead of an LCD, an organic EL (electroluminescence) display can be used, for example.

The operation unit 163 includes a touch panel 165 and a hard key unit 167. The touch panel 165 is a capacitance type. Not only the capacitance type but also another type such as a resistive film type, a surface acoustic wave type, an infrared type and an electromagnetic induction type can be used for the touch panel 165.

The touch panel 165 is provided with its detection surface being superimposed on an upper surface or a lower surface of the display unit 161. The size of the detection surface of the touch panel 165 and the size of the display surface of the display unit 161 are the same. Therefore, the coordinate system of the display surface and the coordinate system of the detection surface are the same. The touch panel 165 detects the position designated by the user on the display surface of the display unit 161 on the detection surface, and outputs a set of coordinates of the detected position to the CPU 111. Because the coordinate system of the display surface and the coordinate system of the detection surface are the same, the set of coordinates output by the touch panel 165 can be replaced with the set of coordinates of the display surface.

The hard key unit 167 includes a plurality of hard keys. The hard keys are contact switches, for example. The touch panel 165 detects a position designated by the user on the display surface of the display unit 161. In the case where operating the MFP 100, the user is likely to be in an upright attitude, so that the display surface of the display unit 161, an operation surface of the touch panel 165, and the hard key unit 167 are arranged to face upward. This is for the purpose of enabling the user to easily view the display surface of the display unit 161 and easily give an instruction on the operation unit 163 with his or her fingers.

The external storage device 117 is controlled by the CPU 111 and mounted with the CD-ROM 118 or a semiconductor memory. While an execution example of the program stored in the ROM 113 by the CPU 111 is described in the present example, the CPU 111 may control the external storage device 117, read out the program to be executed by the CPU 111 from the CD-ROM 118, and store the read program in the RAM 114 for execution.

A recording medium for storing a program to be executed by the CPU 111 is not limited to the CD-ROM 118 but may be a flexible disc, a cassette tape, an optical disc, an IC card, an optical card, or a semiconductor memory. The CPU 111 may download a program from a computer connected to the network 3 and store the downloaded program in the HDD 115, or the computer connected to the network 3 may write the program in the HDD 115, so that the program stored in the HDD 115 is loaded in the RAM 114 and executed by the CPU 111. The program referred to here includes not only a program directly executable by the CPU 111 but also a source program, a compressed program, an encrypted program and the like.

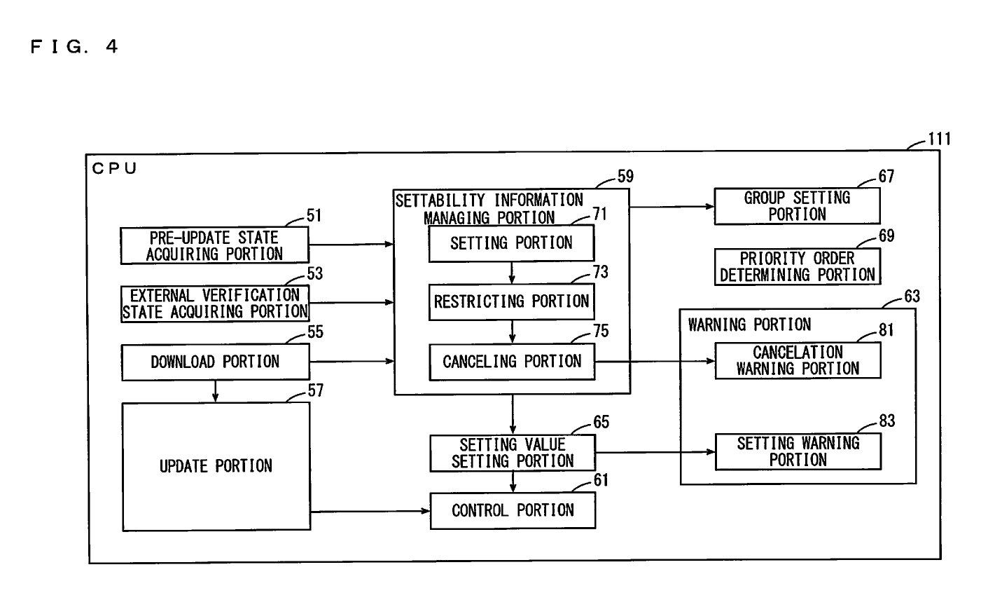

FIG. 4 is a block diagram showing one example of functions of the CPU included in the MFP in one or more embodiments of the present invention. The functions shown in FIG. 4 are functions implemented by the CPU 111 in the case where the CPU 111 included in the MFP 100 executes a firmware update program stored in the ROM 113, the HDD 115 or the CD-ROM 118. Referring to FIG. 4, the CPU 111 includes a pre-update state acquiring portion 51, an external verification state acquiring portion 53, a download portion 55, an update portion 57, a settability information managing portion 59, a control portion 61, a warning portion 63, a setting value setting portion 65, a group setting portion 67 and a priority order determining portion 69.

The download portion 55 manages the version of the firmware installed in the MFP 100, and in the case where firmware newer than the currently installed firmware is available, the download portion 55 downloads the new firmware from the server 200. Specifically, the download portion 55 controls the communication I/F unit 112, makes an inquiry to the server 200 about the version number of the newest firmware, and compares the version number sent from the server 200 with the version number of the currently installed firmware. Thus, the download portion 55 determines that the firmware newer than the currently installed firmware is available.

Here, the currently installed firmware is a first version, and the case where the firmware of a second version that is newer than the firmware of the first version is stored in the server 200 is described as an example. In this case, the download portion 55 controls the communication I/F unit 112, requests the firmware of the second version to the server 200, and receives the firmware of the second version transmitted by the server 200. The download portion 55 outputs the firmware of the second version received from the server 200 to the update portion 57, and outputs the verification state information to the settability information managing portion 59.

Further, in the case where the verification state information is associated with the firmware of the second version, when the MFP 100 requests the firmware of the second version, the server 200 transmits the verification state information to the MFP 100 together with the firmware of the second version. Therefore, in the case where the communication I/F unit 112 receives the verification state information together with the firmware of the second version, the download portion 55 outputs the verification state information to the settability information managing portion 59.

In response to reception of the firmware of the second version from the download portion 55, the update portion 57 updates the firmware of the first version with the firmware of the second version by installing the firmware of the second version.

The pre-update state acquiring portion 51 acquires a settability state with the firmware installed as a pre-update state, the firmware being associated with the corresponding verification state information that does not include an unverified state. The settability state is a state that indicates whether the user can make settings to allow the execution of each of a plurality of processes defined by the firmware. The settability state includes an enabled state where the user can make settings to allow the execution of the process and a disabled state where the user cannot make settings to allow the execution of the process. The pre-update state acquiring portion 51 outputs the pre-update state information indicating the acquired pre-update state to the settability information managing portion 59. Here, the case where the verification state information corresponding to installation of the firmware of the first version does not include the unverified state will be described as an example. In this case, the pre-update state acquiring portion 51 acquires a settability state with the firmware of the first version installed as a pre-update state, and outputs the pre-update state information indicating the pre-update state to the settability information managing portion 59.

In the case where a service provision program installed in the server 200 is updated with the new version in the server 200, the external verification state acquiring portion 53 acquires the server verification state information corresponding to the service provision program of the new version from the server 200. Specifically, the external verification state acquiring portion 53 controls the communication I/F unit 112, requests the server verification state corresponding to the service provision program of the newest version to the server 200, and receives the server verification state information transmitted by the server 200. The external verification state acquiring portion 53 outputs the server verification state information to the settability information managing portion 59.

The settability information managing portion 59 receives the pre-update state information from the pre-update state acquiring portion 51, receives the server verification state information from the external verification state acquiring portion 53, and receives the verification state information from the download portion 55. In response to installation of the firmware of the second version by the update portion 57, the settability information managing portion 59 sets a settability state for each of a plurality of processes defined by the firmware of the second version based on the verification state information and the pre-update state information. The settability information managing portion 59 outputs the settability state that is set for the firmware of the second version to the setting value setting portion 65 and the group setting portion 67.

The settability information managing portion 59, based on the server verification state information, sets an unverified service, the server verification state information of which indicates an unverified state, to the disabled state where settings cannot be made to allow execution of the unverified service by an external server. Therefore, in the control portion 61 that is a task formed in the case where the CPU 111 executes the service instruction program, the process of allowing the external server to execute the unverified service is not executed. Thus, when verification of a non-occurrence of an error during execution of a service has not been completed in the server 200, a process of receiving such a service can be restricted. Therefore, the CPU 111 can receive a service defined by the service provision program of the new version installed in the server 200 as early as possible.

The verification state information defines a verification state of each of a plurality of processes defined by the firmware of the second version downloaded by the download portion 55. The verification state includes a completed state where the verification is completed and an unverified state where the verification is not completed. The settability state indicates whether the user can make settings to allow execution of each process of the plurality of processes, and includes an enabled state where the user can make settings to allow the execution of the process, and a disabled state where the user cannot make settings to allow the execution of the process.

The settability information managing portion 59 includes a setting portion 71, a restricting portion 73 and a canceling portion 75. The setting portion 71 sets a settability state of each verification completed process, that is set in the completed state by the verification state information, out of the plurality of processes defined by the firmware of the second version. The setting portion 71 sets a settability state of each verification completed process out of the plurality of processes defined by the firmware of the second version to a state that is the same as the pre-update state information. Specifically, if the verification completed process is set in the enabled state by the pre-update state information, the setting portion 71 sets the settability state to the enabled state. If the verification completed process is set in the disabled state by the pre-update state information, the setting portion 71 sets the settability state to the disabled state.

As for each unverified process that is set in the unverified state by the verification state information out of the plurality of processes defined by the firmware of the second version, the restricting portion 73 sets the settability state to the disabled state. Thus, the settability state of the unverified process is set to the disabled state, so that the user cannot make settings to allow the execution of an unverified processes. The restricting portion 73 outputs process identification information for identifying the unverified process, the settability state of which is set to the disabled state, to the canceling portion 75.

The canceling portion 75 receives the process identification information of the unverified process, the settability state of which is set to the disabled state, from the restricting portion 73. The unverified state includes an error state where an occurrence of an error is confirmed and an unconfirmed state where an occurrence of an error has not been confirmed. As for the unconfirmed process that is set in the unconfirmed state by the verification state information out of the unverified processes specified by the process identification information received from the restricting portion 73, the canceling portion 75 sets the settability state to the enabled state in accordance with a user operation of inputting in the operation unit 163. Because an occurrence of an error is not confirmed for the unconfirmed process, an error may not occur. Therefore, it is possible to improve user convenience by enabling the user to use the MFP 100.

Further, as for an error process that is set in the error state by the verification state information out of the unverified processes specified by the process identification information received from the restricting portion 73, even when a user operation of inputting in the operation unit 163 is accepted, the canceling portion 75 does not set the settability state to the enabled state and outputs a warning instruction to the warning portion 63. The warning instruction includes the process identification information of the error process. An occurrence of an error is confirmed for the error process. Therefore, the user cannot make settings to allow the execution of the error process, and an occurrence of an error can be prevented. The canceling portion 75 outputs the process identification information of the unconfirmed process, the settability state of which is set to the enabled state, to the warning portion 63.

As for the unconfirmed process specified by the process identification information received from the restricting portion 73, in the case where the enabled state is set by the pre-update state information, the canceling portion 75 may set the settability state to the enabled state. Because a user's operation is not necessary, work to be done by the user can be simplified. Also in this case, the canceling portion 75 outputs the process identification information of the unconfirmed process, the settability state of which is set to the enabled state, to the warning portion 63.

The warning portion 63 includes a cancelation warning portion 81 and a setting warning portion 83. In the case where receiving the process identification information of the unconfirmed process, the settability state of which is set to the enabled state, from the canceling portion 75, the cancelation warning portion 81 displays a first warning message in the display unit 161. The first warning message indicates that the verification of the unverified process, the settability state of which is set to the enabled state, has not been completed. The first warning message may at least include the process identification information of the unconfirmed process, the settability state of which is set to the enabled state. Further, the first warning message may indicate that an error may occur in the case of execution of the unconfirmed process.

As the verification state, the unconfirmed state may include a specific unconfirmed state where an occurrence of an error is confirmed in a specific case. The specific case is the case where the process is executed in combination with another process, for example. In this case, when the verification state of the unconfirmed process specified by the process identification information received from the canceling portion 75 is the specific unconfirmed state, the cancelation warning portion 81 displays a first warning message indicating a condition under which an error occurs in the display unit 161. For example, the first warning message makes notification of the other process that cannot be executed in combination with the process. Therefore, when changing the settability state, the user can be informed of the condition under which an error occurs.

Further, the cancelation warning portion 81 displays a second warning message in the display unit 161 in response to reception of a warning instruction from the canceling portion 75. The second warning message notifies the user that the settings for executing the error process specified by the process identification information included in the warning instruction cannot be made due to an occurrence of an error.

The control portion 61 executes the installed firmware and executes the process defined by the firmware in accordance with a setting value. With the firmware of the first version installed, the control portion 61 executes the process defined by the firmware of the first version in accordance with the setting value. After the firmware of the second version is installed by the update portion 57, the control portion 61 executes the process defined by the firmware of the second version in accordance with the setting value.

The setting value setting portion 65 receives a settability state for each of a plurality of processes defined by the firmware of the second version from the settability information managing portion 59. The setting value setting portion 65 sets a setting value for each process, the settability state of which is set to the enabled state, out of the plurality of processes defined by the firmware of the second version in accordance with a user operation of inputting in the operation unit 163. In the case where the settability state of the process that is a subject of a user operation of inputting in the operation unit 163 is set to the enabled state, the setting value setting portion 65 sets the setting value. In the case where the settability state of the process that is a subject of the user operation of inputting in the operation unit 163 is set to the disabled state, the setting value setting portion 65 does not set a setting value, and outputs a warning instruction to the warning portion 63. The warning instruction includes the process identification information of a process that is a subject of a user operation of inputting in the operation unit 163. The setting value setting portion 65 outputs a setting value set for each of a plurality of processes defined by the firmware of the second version to the control portion 61.

In the case where the verification state of the process that is a subject of a user input operation is the unverified state, the setting value setting portion 65 outputs the process identification information of the process that is a subject of the user input operation to the warning portion 63.

In the case where the verification state of the process specified by the process identification information received from the setting value setting portion 65 is the unconfirmed state, the setting warning portion 83 displays the first warning message in the display unit 161. The first warning message indicates that the verification of the unconfirmed process specified by the process identification information received from the setting value setting portion 65 has not been completed. Thus, the first warning message is displayed when the user is performing an operation of setting a setting value to allow execution of the process. Therefore, the user who is setting the setting value can be notified of incompletion of the verification of the process for which the setting value has been set. Thus, when setting the setting value, the user can select whether to allow the execution of the unconfirmed process.

Further, in the case where the verification state of the process specified by the process identification information received from the setting value setting portion 65 is the specific unconfirmed state, the setting warning portion 83 displays the first warning message indicating the condition under which an error occurs in the display unit 161. For example, the first warning message indicates another process that cannot be executed in combination with the process. Therefore, when setting a setting value, the user can make settings to allow execution of the process in combination with another process such that an error does not occur.

Further, in the case where receiving a warning instruction from the setting value setting portion 65, the setting warning portion 83 displays the second warning message in the display unit 161. The second warning message notifies the user that the setting of executing the error process specified by the process identification information included in the warning instruction cannot be made.

The group setting portion 67 receives settability states corresponding to the firmware of the second version from the settability information managing portion 59. In response to the change of settings of the MFP 100, the group setting portion 67 allows another device that belongs to the same group as the MFP 100 to install the firmware of the second version, and allows the other device to set the settability states to the same settabillity states set in the MFP 100. The group includes devices in which the same firmware is installed. The case where the MFPs 100, 100A, 100B belong to the same group will be described here as an example.

In response to reception of the settability states corresponding to the firmware of the second version from the settability information managing portion 59, the group setting portion 67 allows another device that belongs to the same group, for example, the MFP 100A, to install the firmware of the second version, and transmits an installation instruction to the MFP 100A in order to allow the settability states of the MFP 100A to be set to the settability states set in the MFP 100. The installation instruction includes the firmware of the second version and the settability states set in the MFP 100. In the MFP 100A, the firmware of the second version is installed in accordance with the installation instruction, and the settability states included in the installation instruction are set. In the same group, the devices in which the same type of firmware is installed are included.

The priority order determining portion 69 determines the priority order of verification of the unverified processes, that are set in the unverified state by the verification state information, out of the plurality of processes defined by the downloaded firmware of the second version. The priority order determining portion 69 notifies the server 200 of the determined priority order. Therefore, the priority order is determined for the unverified processes, so that a person in charge of the verification can be notified of the order of verification of the plurality of processes defined by the firmware of the second version.

Specifically, the more frequently the execution process has been executed by the control portion 61 in the past, the higher priority order the priority order determining portion 69 gives to the execution process. Therefore, the higher priority order is given to the execution process that has been executed in the MFP 100. Thus, the firmware of the second version can be verified according to the operating history of the MFP 100.

Further, the priority order determining portion 69 may give a higher priority order to an unverified process, the settability state of which is set to the enabled state in the MFP 100. In this way, the process that is likely to be used by the user can be given priority to be verified.

The priority order determining portion 69 may determine the priority order only based on the operating history, may determine the priority order only based on the settability states, or may determine the priority order based on a combination of the operating history and the settability states.

Determination of the priority order is preferably made in the server 200. Therefore, each of the MFPs 100, 100A, 100B transmits the history and the settability states that are required for the server 200 to determine the priority order to the server 200, and then the server 200 determines the priority order of the processes of performing verification based on the information received from each of the MFPs 100, 100A, 100B.

FIG. 5 is a flow chart showing one example of a flow of a firmware update process in one or more embodiments of the present invention. The firmware update process is a process executed by the CPU 111 in the case where the CPU 111 included in the MFP 100 executes a firmware update program stored in the ROM 113, the HDD 115 or the CD-ROM 118. Referring to FIG. 5, the CPU 111 determines whether firmware update is available. If the firmware of the version newer than the version of the currently installed firmware is available, the CPU 111 determines that firmware update is available. The CPU 111 determines whether firmware update is available by inquiring the server 200. If firmware update is available (YES in the step S01), the process proceeds to the step S02. If firmware update is not available, the process proceeds to the step S14.

In the step S02, the CPU 111 downloads the firmware of a new version. Specifically, the CPU 111 transmits a download request to the server 200, and receives the firmware transmitted by the server 200 that has received the download request. Here, the currently installed firmware is referred to as the firmware of the first version, and the firmware to be downloaded from the server 200 is referred to as the firmware of the second version.

In the step S03, the CPU 111 acquires verification state information from the server 200. The CPU 111 receives the verification state information transmitted by the server 200 together with the firmware of the second version. In the next step S04, the CPU 111 acquires the currently set settability states. The settability states are set for the currently installed firmware of the first version. Then, the CPU 111 updates the firmware of the first version with the firmware of the second version by installing the downloaded firmware of the second version (step S05).

In the next step S06, the CPU 111 selects one of the plurality of processes defined by the firmware of the second version as a process to be executed. In the next step S07, the CPU 111 determines whether the settability state of the selected process is set to the enabled state before the update. If the settability state is set to the enabled state, the process proceeds to the step S08. If not, the process proceeds to the step S12. In the step S12, the CPU 111 sets the settability state of the process selected out of the plurality of processes defined by the firmware of the second version to the disabled state, and the process proceeds to the step S13. In the case where the process is set in the disabled state in the firmware of the first version, the process is set in the disabled state in the firmware of the second version. Thus, the same settability state can be set before and after the update.

In the step S08, the process branches according to the verification state of the selected process. The verification state is defined by the verification state information acquired in the step S03. If the verification state is the completed state, the process proceeds to the step S09. If the verification state is the error state, the process proceeds to the step S10. If the verification state is the unconfirmed state, the process proceeds to the step S11. In the step S09, the settability state of the process selected out of the plurality of processes defined by the firmware of the second version is set to the enabled state, and the process proceeds to the step S13. In the case where the process is set in the enabled state in the firmware of the first version, the process is set in the enabled state in the firmware of the second version. Thus, the same settability state can be set before and after the update. Further, because the verification state is the completed state, it is confirmed that an error does not occur with the firmware of the second version. Therefore, even when the process is set in the enabled state, the firmware of the second version can run successfully.

In the step S10, the settability state of the process selected out of the plurality of processes defined by the firmware of the second version is set to the disabled state, and the process proceeds to the step S13. Even in the case where the process is set in the enabled state in the firmware of the first version, the process is set in the disabled state in the firmware of the second version. In the case where the verification state is the error state, it is confirmed that an error occurs in the firmware of the second version. Thus, the settability state is set to the disabled state, so that the process is not executed. Thus, the firmware of the second version can run successfully.

In the step S11, the settability state of the process selected out of the plurality of processes defined by the firmware of the second version is set to the disabled state, and the process proceeds to the step S13. Even in the case where the process is set in the enabled state is set in the firmware of the first version, the process is set in the disabled state in the firmware of the second version. In the case where the verification state is the unconfirmed state, it is not confirmed that an error does not occur in the firmware of the second version. Thus, the settability state is set to the disabled state, and the process is not executed. Thus, the firmware of the second version can run successfully.

In the step S13, the CPU 111 determines whether a process that is not selected as a process to be executed in the step S06 is present among the plurality of processes defined by the firmware of the second version. If the unselected process is present, the process returns to the step S06. If not, the process proceeds to the step S14.

In the step S14, the CPU 111 determines whether a switching operation of switching the settability state to the enabled state has been accepted. If the switching operation of inputting in the operation unit 163 performed by the user is accepted, the process proceeds to the step S15. If not, the process returns to the step S06. In the step S15, the CPU 111 specifies the process that is a subject of the switching operation, and the process proceeds to the step S16. In the step S16, the process branches according to the verification state of the specified process. The CPU 111 determines the verification state corresponding to the process specified in the step S15 out of the plurality of processes defined by the currently installed firmware. The verification state is determined in the step S03 with reference to the most recently acquired verification state information. If the verification state is the completed state, the process proceeds to the step S17. If the verification state is the unconfirmed state, the process proceeds to the step S18. If the verification state is the error state, the process proceeds to the step S19. In the step S17, the settability state is set to the enabled state, and the process proceeds to the step S20.

In the step S18, the first warning message is displayed in the display unit 161, and the process proceeds to the step S17. In the step S17, the settability state is set to the enabled state, and the process proceeds to the step S20. The first warning message makes notification that a non-occurrence of an error during execution of the process, the settability state of which is set to the enabled state, is not confirmed. Because the settability state is set to the enabled state, the user can make settings to allow the execution of the process at a time point at which the settability state is set. However, the user can be informed of possibility of an occurrence of an error in the case of execution of the process. Further, in the case where the verification state of the unconfirmed process is a specific unconfirmed state, the CPU 111 displays the first warning message indicating a condition under which an error occurs. For example, the first warning message makes notification of another process that cannot be executed in combination with the process. Therefore, although being able to make settings to allow the execution of the process, the user can be informed when changing the settability state of the condition under which an error occurs.

In the step S19, the CPU 111 displays the second warning message in the display unit 161, and the process returns to the step S06. The second warning message is a message for making notification of an occurrence of an error if the process is executed. Therefore, the user can be informed at the time of setting the settability state that the settability state cannot be set to the enabled state due to an occurrence of an error if the process is executed. Further, in the case where the process proceeds to the step S19, the disabled state of the settability state is maintained. Thus, the user cannot make settings to allow the execution of the process, so that an occurrence of an error can be prevented. In the step S20, a group setting process is executed, and the process returns to the step S01.

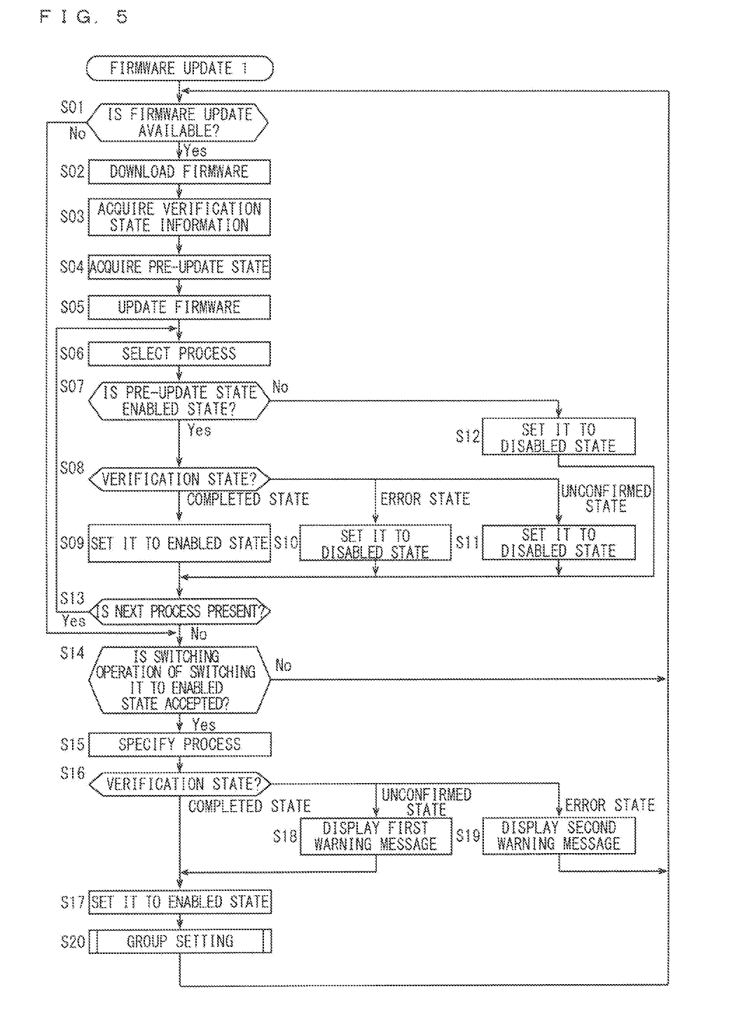

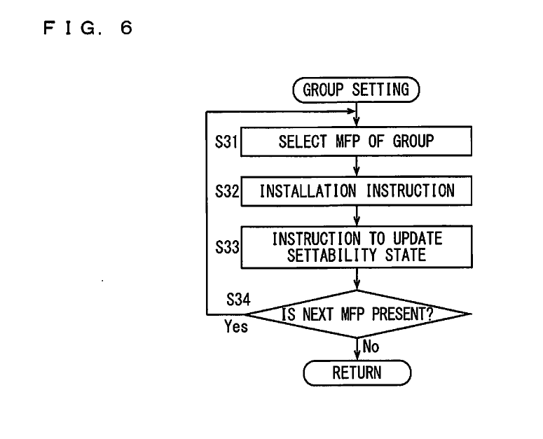

FIG. 6 is a flow chart showing one example of a flow of the group setting process. Referring to FIG. 6, the CPU 111 selects an MFP that belongs to the same group as the MFP 100 (step S31). Here, the case where the MFPs 100A, 100B belong to the same group as the MFP 100 and the MFP 100A is selected is described as an example.

Then, the CPU 111 acquires the settability states set in the MFP 100A from the selected MFP 100A (step S32). The CPU 111 controls the communication I/F unit 112, and transmits an installation instruction to the MFP 100A. The installation instruction includes the firmware of the second version and the settability states set in the MFP 100. In the MFP 100A that receives the installation instruction, the firmware of the second version is installed in accordance with the installation instruction, and the settability states included in the installation instruction are set.

In the step S34, the CPU 111 determines whether an MFP that is not selected in the step S31 is present. If an unselected MFP is present, the process returns to the step S31. If not, the process returns to the firmware update process. Here, because the MFP 100B is not selected, the process proceeds to the step S31, and the CPU 111 transmits the installation instruction to the MFP 100B (step S33).

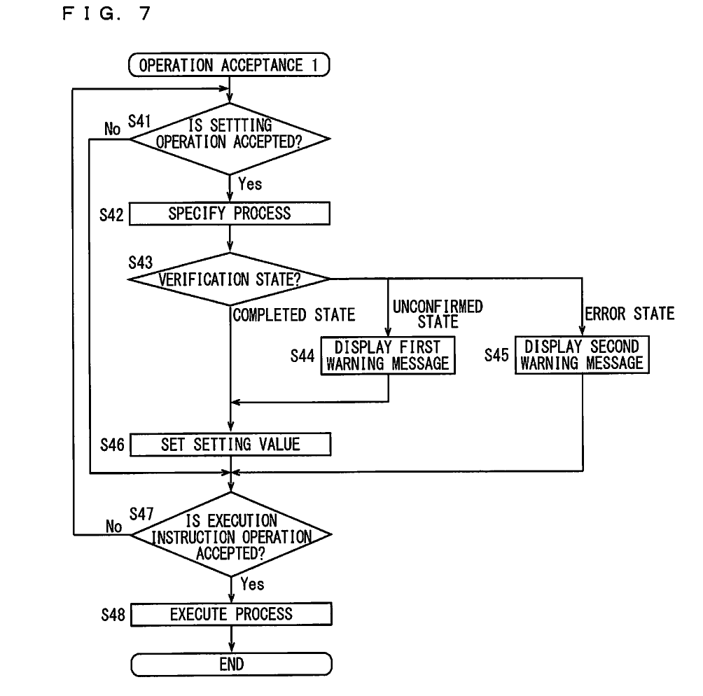

FIG. 7 is a flow chart showing one example of a flow of an operation acceptance process in one or more embodiments of the present invention. The operation acceptance process is executed by the CPU 111 in the case where the CPU 111 included in the MFP 100 executes an operation acceptance program stored in the ROM 113, the HDD 115 or the CD-ROM 118. The operation acceptance program is part of the firmware update program. Referring to FIG. 7, the CPU 111 included in the MFP 100 determines whether a setting operation of inputting in the operation unit 163 by the user has been accepted (step S41). The setting operation is an operation of setting a setting value for allowing the MFP 100 to execute the process. The setting operation is an operation of setting a setting value for one of the plurality of processes defined by the firmware installed in the MFP 100. The setting value includes a value indicating whether the process is executed. While accepting the setting operation for the process, the settability state of which is set to the enabled state, the CPU 111 does not accept the setting operation for the process, the settability state of which is set to the disabled state. This is because an input cannot be made by the setting operation for the process, the settability state of which is set to the disabled state. If the setting operation is accepted, the process proceeds to the step S42. If not, the process proceeds to the step S48.

In the step S42, the CPU 111 specifies the process corresponding to the setting operation, and the process proceeds to the step S43. The CPU 111 specifies which one of the plurality of processes defined by the firmware installed in the MFP 100 the setting operation corresponds to. Then, the process branches according to the verification state of the specified process (step S43). In the step S43, if the verification state is the completed state, the process proceeds to the step S46. If the verification state is the unconfirmed state, the process proceeds to the step S44. If the verification state is the error state, the process proceeds to the step S45.

In the step S44, the first warning message is displayed in the display unit 161, and the process proceeds to the step S46. The first warning message makes notification that a non-occurrence of an error during execution of the process, the settability state of which is set to the enabled state, has not been confirmed. Therefore, when changing the settability state, the user can be informed of a risk of an occurrence of an error. Further, in the case where the verification state is the specific unconfirmed state, the first warning message indicating the condition under which an error occurs is displayed in the display unit 161. The first warning message described here makes notification of another process that cannot be executed in combination with the process. Therefore, when changing the settability state, the user can be informed of the condition under which an error occurs.

In the step S45, the second warning message is displayed in the display unit 161, and the process proceeds to the step S46. The second warning message makes notification that the setting for allowing the execution of the error process specified by the process identification information included in the warning instruction cannot be made since an error occurs if the process is executed. Therefore, when setting a setting value, the user can be informed that he or she cannot set the setting value since an error occurs if the process is executed with the setting value.

In the step S46, the CPU 111 sets a setting value for the process specified in the step S42 in accordance with the setting operation accepted in the step S41, and the process proceeds to the step S47. In the case where the process proceeds to the step S44, the setting value is set. Thus, the user can make settings to allow the execution of the process. However, because the first warning message is displayed in the step S44, the user can be informed, when setting the setting value, of the possibility of an occurrence of an error in the case where the process is executed.

In the step S47, the CPU 111 determines whether the execution instruction operation of inputting in the operation unit 163 by the user has been accepted. The execution instruction operation is an operation for allowing the MFP 100 to execute a process. The execution instruction operation is an operation of allowing execution of one or more processes out of the plurality of processes defined by the firmware installed in the MFP 100. If the execution instruction operation is accepted, the process proceeds to the step S48. If not, the process returns to the step S41. In the step S48, the CPU 111 executes one or more processes out of the plurality of processes defined by the firmware installed in the MFP 100 in accordance with the setting value set in the step S46, and the process ends.

<Specific Examples>

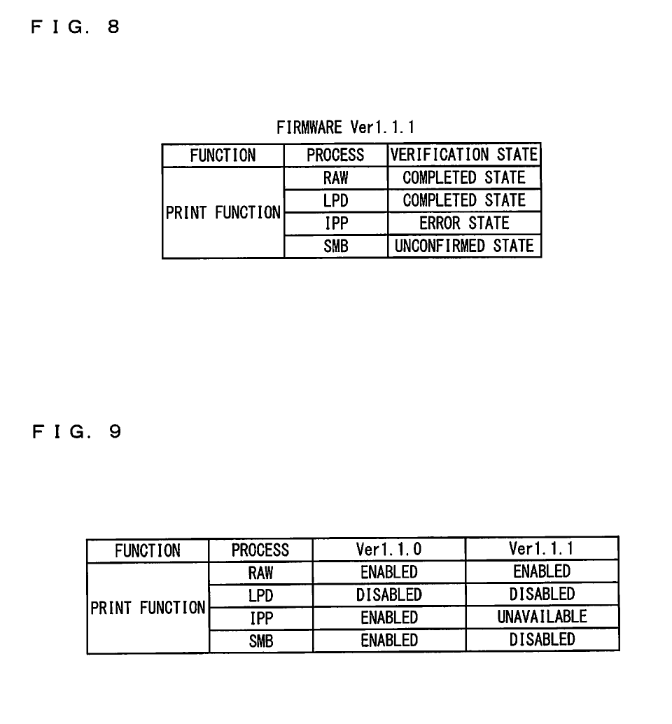

FIG. 8 is a diagram showing one example of the verification state information of the firmware of the second version. Referring to FIG. 8, the first version is the version 1.1.1, and the respective verification states of the respective four processes included in a print function defined by the firmware of the first version are shown. The verification state information indicates a verification state of each process. Here, the case where the print function includes four processes using RAW, LPD (Line Printer Daemon Protocol), IPP (Internet Printing Protocol) and SMB (Server Message Block) of different communication protocols for receiving print data.

The completed state is set as the verification state of the process RAW, the completed state is set as the verification state of the process LPD, the error state is set as the verification state of the process IPP, and the unconfirmed state is set as the verification state of the process SMB.

FIG. 9 is a diagram showing one example of the settability states. Here, the settability states set for the firmware of the first version 1.1.0 and the settability states set for the firmware of the second version 1.1.1 are shown. Here, the settability states for the firmware of the second version indicate the values to be set in the case where the verification state information of the firmware of the second version shown in FIG. 8 is acquired.

Referring to FIG. 9, the settability state of the process RAW to be executed when the firmware of the first version 1.1.0 is installed is set to the setting value “ENABLED” indicating the enabled state, and the verification state of the process RAW is set to the completed state. Thus, the settability state of the process RAW to be executed when the firmware of the second version 1.1.1 is installed is set to the setting value “ENABLED” indicating the enabled state that is the same as the settability state set for the firmware of the first version 1.1.0.

The settability state of the process LPD to be executed when the firmware of the first version 1.1.1 is installed is set to the setting value “DISABLED” indicating the disabled state, and the verification state of the process LPD is set to the completed state. Thus, the settability state of the process LPD to be executed when the firmware of the second version 1.1.1 is installed is set to the setting value “DISABLED” indicating the disabled state that is the same as the settability state set for the firmware of the first version 1.1.0.

The settability state of the process IPP to be executed when the firmware of the first version 1.1.0 is installed is set to the setting value “ENABLED” indicating the enabled state, and the verification state of the process IPP is set to the error state. Thus, the settability state of the process IPP to be executed when the firmware of the second version 1.1.1 is installed is set to the setting value “UNAVAILABLE” indicating the disabled state. Here, the setting value “UNAVAILABLE” indicates that the settability state of the process is the disabled state, and the verification state of the process is the error state.

The settability state of the process SMB to be executed when the firmware of the first version 1.1.0 is installed is set to the setting value “ENABLED” indicating the enabled state, and the verification state of the process SMB is set to the unconfirmed state. Thus, the settability state of the process SMB to be executed when the firmware of the second version 1.1.1 is installed is set to the setting value “DISABLED” indicating the disabled state. Here, the setting value “DISABLED” indicates that the settability state of the process is the disabled state, and the verification state of the process is the unconfirmed state.

FIG. 10 is a diagram showing one example of a settability state setting screen with the firmware of the first version installed. Referring to FIG. 10, as for the print function, the setting value “ENABLED” indicating that the process RAW is set to the enabled state is set, the setting value “DISABLED” indicating that the process LPD is set to the disabled state is set, the setting value “ENABLED” indicating that the process IPP is set to the enabled state is set, and the setting value “ENABLED” indicating that the process SMB is set to the enabled state is set.

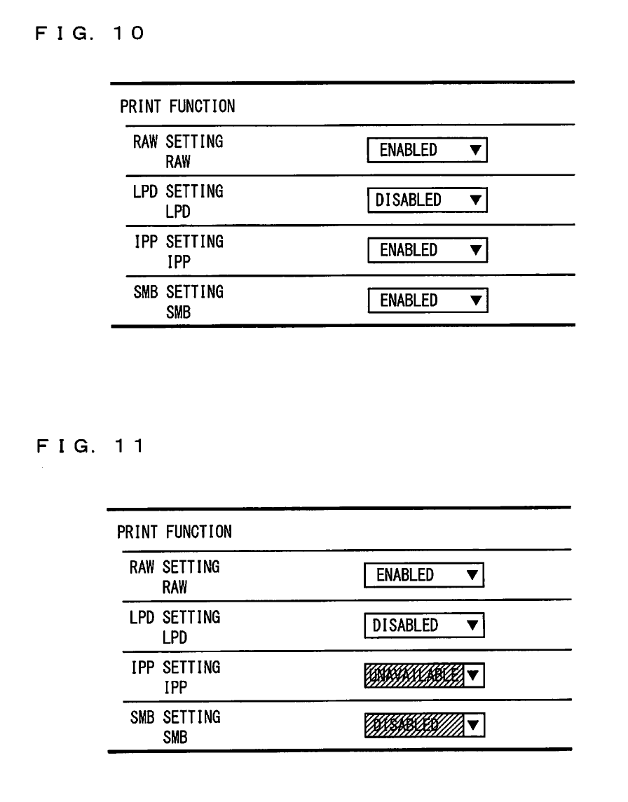

FIG. 11 is a first diagram showing one example of the settability state setting screen with the firmware of the second version installed. Referring to FIG. 11, as for the print function, the setting value “ENABLED” indicating that the process RAW is set to the enabled state is set, and the setting value “DISABLED” indicating that the process LPD is set to the disabled state is set. The setting value “UNAVAILABLE” indicating that the process IPP is set to the disabled state is set, and the setting value “DISABLED” indicating that the process SMB is set to the disabled state is set.

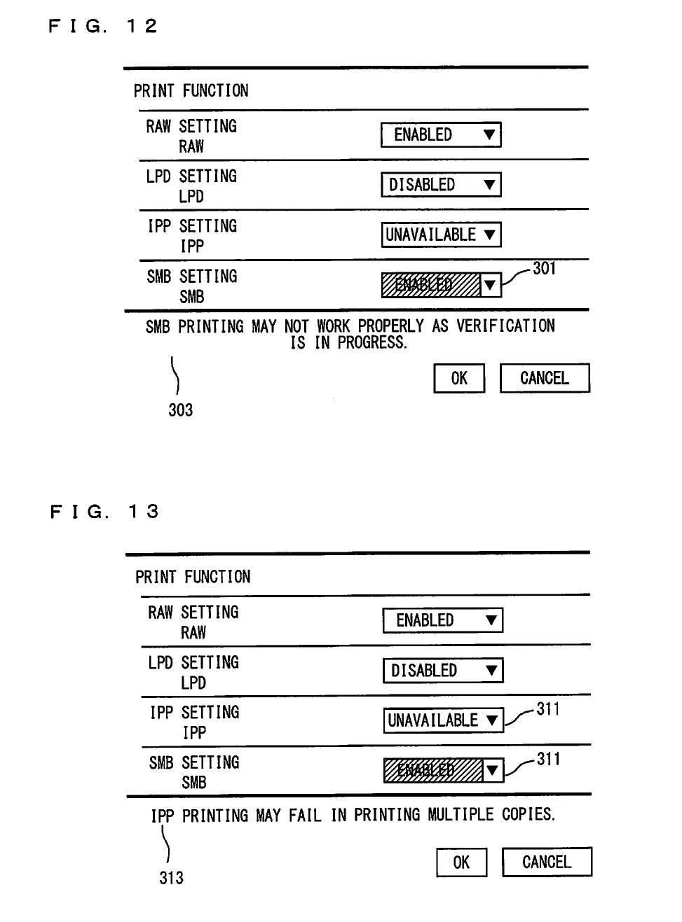

FIG. 12 is a second diagram showing one example of the settability state setting screen with the firmware of the second version installed. FIG. 12 shows the settability state setting screen shown in FIG. 11 in the case where the setting value is changed to “ENABLED” indicating the enabled state in a region 301 for setting of the settability state of the process SMB. In this case, a message 303 including the character string “SMB printing may not work properly as verification is in progress.” is displayed as a first warning message. Thus, the user can be notified that, although the user can make settings to execute the SMB printing, an error may occur.

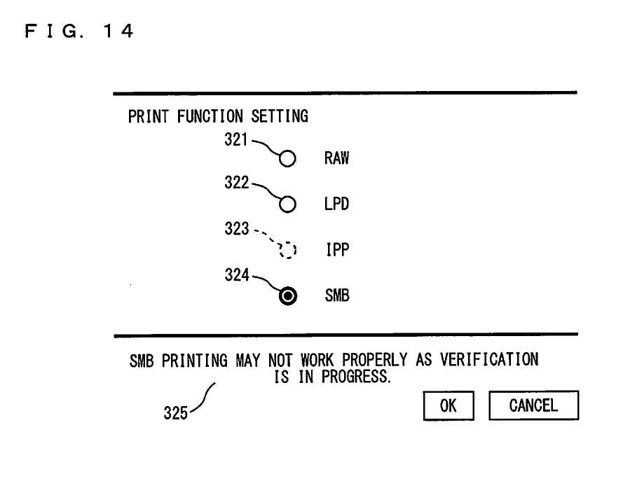

FIG. 13 is a third diagram showing one example of the settability state setting screen with the firmware of the second version installed. FIG. 13 shows the settability state setting screen shown in FIG. 11 in the case where the setting value is changed to “ENABLED” in a region 311 for setting of the settability state of the process IPP. Here, it is indicated that the verification state of the process SMB is the specific unconfirmed state where an occurrence of an error has been confirmed when the process SMB is executed in combination with a multiple copies printing process of printing a plurality of number of copies as an example.

In this case, a message 313 including the character string “IPP printing may fail in printing multiple copies.” is displayed as a first warning message. Thus, the user can be notified that, although the user can make settings to execute the IPP printing, an error may occur in the case where the IPP printing is executed in combination with the multiple copies printing process specified as a specific process.

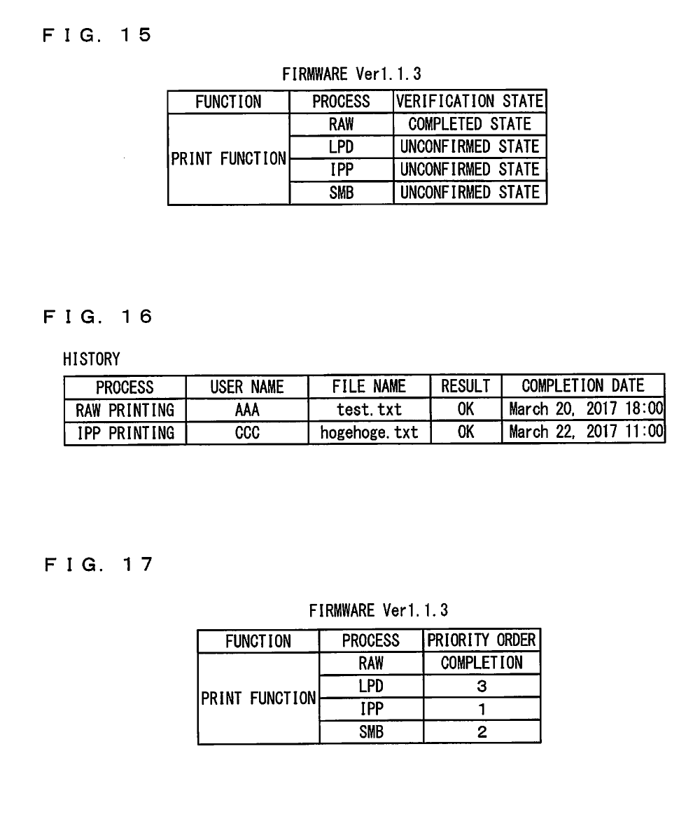

FIG. 14 is a diagram showing one example of a setting screen. The setting screen shown in FIG. 14 is the setting screen that is displayed after the settability state of the process SMB is set to the enabled state in the settability state setting screen. Referring to FIG. 14, the setting screen includes radio buttons 321 to 324 for respectively setting setting values for the process RAW, the process LPD, the process IPP and the process SMB. The radio buttons 321 to 324 are exclusively selectable, and one of the radio buttons 321 to 324 can be selected at a time. FIG. 14 shows that the radio button 324 corresponding to the process SMB is selected, and the setting value for the process SMB is set. Further, the settability state of the process IPP is set to “UNAVAILABLE” indicating the disabled state, so that the unselectability of the radio button 323 is indicated. In the diagram, a dotted line indicates the unselectability of the radio button 323. In the case where an instruction of selecting the radio button 323 is accepted, the message including the character string “IPP printing may fail in printing multiple copies.” may be displayed as the first warning message.

Because the verification state of the process SMB is the unconfirmed state, a message 325 including the character string “SMB printing may not work properly as verification is in progress.” is displayed when the radio button 324 corresponding to the process SMB is selected. Thus, the user can be notified when setting a setting value for execution of the process that a non-occurrence of an error during execution of the process has not been confirmed.

FIG. 15 is a diagram showing one example of the verification state information for the firmware of a third version. Referring to FIG. 15, the third version is the version 1.1.3, and the respective verification states of the respective four processes included in the print function defined by the firmware of the third version are shown. The verification state information indicates a verification state for each process.

The verification state of the process RAW is set to the completed state, and the verification states of the process LPD, the process IPP and the process SMB are respectively set to the unconfirmed state.

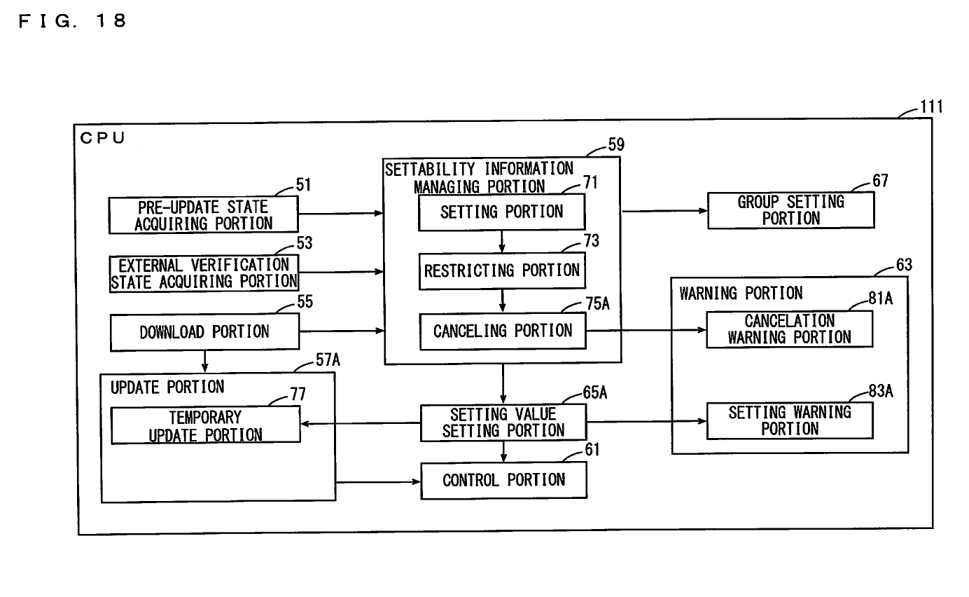

FIG. 16 is a diagram showing one example of history information. Referring to FIG. 16, the history information defines user names, file names, results of execution of processes and the dates of the execution of the processes. Here, the history information includes the record of the successful execution of the process RAW on the data of the file name “test. txt” by the user “AAA” at 18:00 on 20, Mar., 2017, and the record of the successful execution of the process SMB on the data of the file name “hogehoge.text” by the user “CCC” at 11:00 on 22, Mar., 2017.

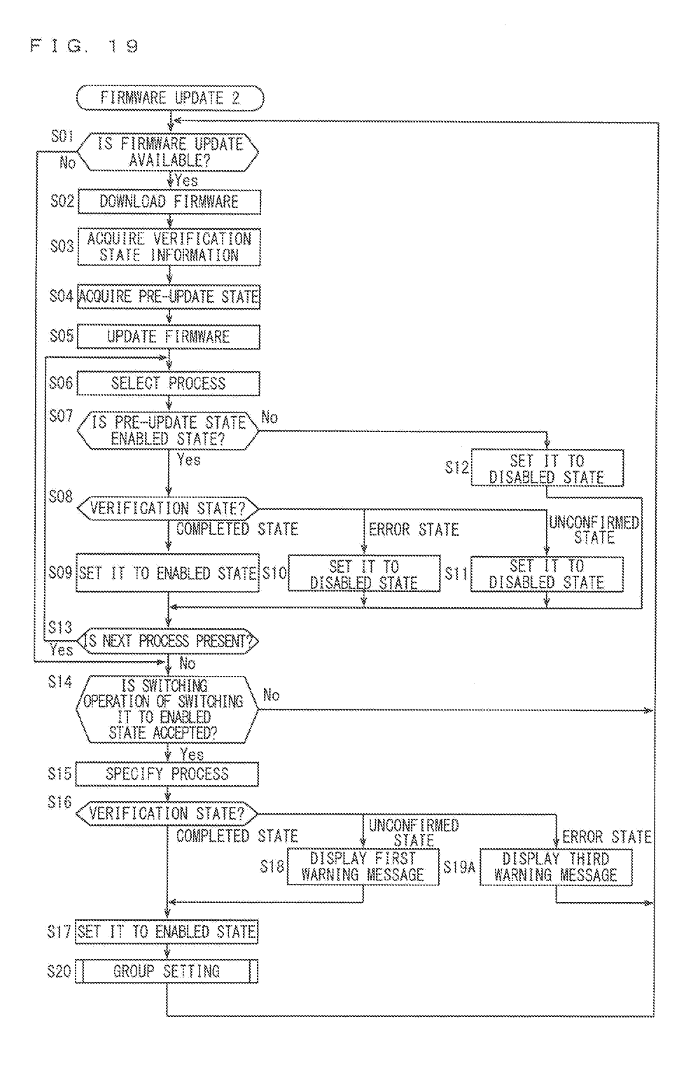

FIG. 17 is a diagram showing one example of the priority order. Referring to FIG. 17, the priority order is defined for each process, the verification of which has not been completed. The verification state of the process RAW is the completed state. Therefore, the priority order is not given. In the history information shown in FIG. 16, there is the record of execution of the process RAW and the process IPP in the history information shown in FIG. 16, so that the highest priority order “1” is set for the process IPP. Thus, the process that has been executed in the past is given higher priority for verification, so that the user can be provided with the firmware that works properly as early as possible. The priority order of the process LPD is set to “3”, and the priority order of the process SMB is set to “2”. This is because the settability state of the process SMB is set to the enabled state, and the settability state of the process LPD is set to the disabled state, in the settability state setting screen shown in FIG. 12. In other words, the process, the settability state of which is set to the enabled state, is given higher priority than the process, the settability state of which is set to the disabled state. Thus, the higher the likelihood of execution of the process is, the higher the priority for the verification is. Therefore, the user can be provided with the firmware that works properly as early as possible.

As described above, the MFP 100 in one or more embodiments of the present invention functions as an information processing apparatus, downloads a set of the firmware of the second version and the verification state information from the server 200, updates the firmware of the first version with the firmware of the second version, sets the settability state of the unverified process out of the plurality of processes defined by the firmware of the second version to the disabled state, and changes the settability state of the unverified process from the disabled state to the enabled state where the user can make settings to allow the execution. Therefore, when verification of a non-occurrence of an error during execution of a process has not been completed, the user can make settings to allow the execution of such a process. Because an error may not occur during execution of the unverified process, it is possible to improve user convenience by allowing the user to execute the unverified process.

Further, in the case where the settability state of the unverified process is set to the enabled state, the user is notified by the first warning message indicating that the verification has not been completed. Thus, the user can be informed of the risk of an occurrence of an error.

Further, the user is notified of the first warning message indicating that the verification has not been completed in response to the setting for allowing the execution of the unverified process, the settability of which is set to the enabled state in accordance with a user input operation. Therefore, the user who has instructed the execution of the unverified process can be informed of the risk of an occurrence of an error.

Further, in the case where the settability state of an unverified process is set to the enabled state with the firmware of the first version installed before the installation of the firmware of the second version, the settabiilty state of the unverified process defined by the firmware of the second version is set to the enabled state. Therefore, the user can make settings for as many of the same processes as possible before and after the update of the firmware.

Further, the verification completed process, the verification of which has been completed, is set in the settability state that is set when the firmware of the first version is installed. Thus, the user can make settings for as many of the same processes as possible before and after the update of the firmware.

Further, the firmware of the second version is installed in the other MFPs 100A, 100B that belong to the same group as the MFP 100, and the settability states set for the MFP 100 are set for the MFPs 100A, 100B. Therefore, an operation of upgrading the firmware in each of the MFPs 100A, 100B and an operation of making settings for the firmware can be simplified.

Further, the MFP 100 acquires the server verification state information from the server 200, and sets the service, which is provided by the server 200 and indicates an unverified state, in the disabled state. Thus, verification of a non-occurrence of an error during execution of a process has not been completed, execution of a process of receiving such a service can be restricted. Therefore, the service of the new version installed in the server can be received as early as possible.

In the MFP 100 in one or more embodiments of the present invention, in the case where the verification state of a process is the unverified state and the unconfirmed state, the user can set the settability state of the process to the enabled state. However, in the case where the verification state is the error state, the user cannot set the settability state to the enabled state. In the first modified example, in addition to the case where the verification state is the unconfirmed state, also in the case where the verification state is the error state, the user can make settings to execute an unverified process that is in the unverified state.

FIG. 18 is a block diagram showing one example of an outline of functions of the CPU of the MFP in the modified example of one or more embodiments of the present invention. Referring to FIG. 18, differences from the functions shown in FIG. 4 are that the update portion 57, the canceling portion 75, the setting value setting portion 65, the cancelation warning portion 81 and the setting warning portion 83 are changed to an update portion 57A, a canceling portion 75A, a setting value setting portion 65A, a cancelation warning portion 81A and a setting warning portion 83A. The other functions are the same as the functions shown in FIG. 4. Therefore, a description thereof will not be repeated. The update portion 57A includes a temporary update portion 77.

The canceling portion 75A receives the process identification information of an unverified process, the settability state of which is set to the disabled state by the restricting portion 73. The unverified state includes an error state where an occurrence of an error is confirmed, and an unconfirmed state where an occurrence of an error has not been confirmed. The canceling portion 75A sets the settability state of an unverified process specified by the process identification information received from the restricting portion 73 to the enabled state in accordance with the user operation of inputting in the operation unit 163. The canceling portion 75A outputs the process identification information of the unverified process, the settability state of which is set to the enabled state, to the warning portion 63.

In the case where the settability state is set to the enabled state by the pre-update state information, the canceling portion 75A may set the settability state of the unverified process specified by the process identification information received from the restricting portion 73 to the enabled state. Since a user operation is not required, the work to be done by the user can be simplified. Also in this case, the canceling portion 75A outputs the process identification information of the unverified process, the settability state of which is set to the enabled state, to the warning portion 63.

In the case where the process identification information of the unverified process is received from the canceling portion 75A, and the verification state of the unverified process is the unconfirmed state, the cancelation warning portion 81A displays the first warning message in the display unit 161. In the case where the verification state of the unverified process is the unconfirmed state, the first warning message indicates that the verification of the unverified process, the settability state of which is set to the enabled state, has not been completed. The first warning message may be a message indicating that an error may occur in the case where the unconfirmed process is executed. Further, in the case where the verification state of the unverified process is the specific unconfirmed state, the first waring message indicates a condition under which an error occurs. For example, the first warning message makes notification of another process that cannot be combined with the process.

Further, in the case where the cancelation warning portion 81A receives the process identification information of the unverified process from the canceling portion 75, and the verification state of the unverified state is the error state, the cancelation warning portion 81A displays a third warning message in the display unit 161. In the case where the execution of the unverified process is instructed, the third warning message is the message for making notification of the update of the firmware with the firmware of the former version.

The setting value setting portion 65A receives the settability state for each of the plurality of processes defined by the firmware of the second version from the settability information managing portion 59. The setting value setting portion 65A sets the setting value for each process, the settability state of which is set to the enabled state, out of the plurality of processes defined by the firmware of the second version in accordance with the user operation of inputting in the operation unit 163. The setting value setting portion 65A does not set the setting value for the process, the settability state of which is set to the disabled state. The setting value setting portion 65A outputs the setting value set for each of the plurality of processes defined by the firmware of the second version to the control portion 61.

In the case where the verification state of the process that is a subject of a user input operation is the unverified state, the setting value setting portion 65A outputs the process identification information of the unverified process that is a subject of the operation to the setting warning portion 83A. The unverified state includes the unconfirmed state and the error state. Further, in the case where the verification state of the process that is a subject of a user input operation is an error state, the setting value setting portion 65 outputs an update instruction to the temporary update portion 77.

In the case where the setting warning portion 83A receives the process identification information of the unverified process from the setting value setting portion 65, and the verification state of the unverified process is the unconfirmed state, the setting warning portion 83A displays a first warning message in the display unit 161. In the case where the verification state of the unverified process is the unconfirmed state, the first warning message indicates that the verification of the unverified process, the settability state of which is set to the enabled state, has not been completed. The first warning message may be a message indicating that an error may occur in the case where the unconfirmed process is executed. Further, in the case where the verification state of the unverified process is the specific unconfirmed state, the first warning message indicates the condition under which an error occurs. For example, the first warning message makes notification of another process that cannot be executed in combination with the process. Therefore, the user can select whether to execute the unconfirmed process when setting a setting value.

Further, in the case where the process identification information of the unverified process is received from the setting value setting portion 65, and the verification state of the unverified process is the error state, the setting warning portion 83A displays the third warning message in the display unit 161. The third warning message is a message for making notification of the update of the firmware with the firmware of the former version. Therefore, the user can make settings and combine processes so as to prevent an occurrence of an error when setting a setting value. Thus, the user can select whether to execute the unconfirmed process when setting a setting value.

In response to reception of an update instruction from the setting value setting portion 65A with the firmware of the second version installed, the temporary update portion 77 updates the firmware by installing the firmware of the first version. The control portion 61 executes a process in accordance with a setting value set by the setting value setting portion 65A after the firmware of the second version is installed. When the process ends, the temporary update portion 77 updates the firmware by installing the firmware of the second version.

The control portion 61 executes the installed firmware, and executes a process defined by the firmware in accordance with a setting value. With the firmware of the first version installed, the control portion 61 executes the process defined by the firmware of the first version in accordance with the setting value. After the firmware of the second version is installed by the update portion 57, the control portion 61 executes the process defined by the firmware of the second version in accordance with the setting value.

Because an occurrence of an error is not confirmed for an unconfirmed process, an error may not occur. Therefore, it is possible to improve user convenience by enabling the user to use the MFP 100. Further, because an occurrence of an error is confirmed for an error process, it is known in advance that an error occurs if the process is executed with the firmware of the second version installed. Therefore, in the case where the user makes settings to allow the execution of the error process, the firmware of the first version is installed. Thus, an occurrence of an error can be prevented. Further, the firmware of the second version is installed after the execution of the process, so that the MFP 100 can be installed with the firmware of the newest version.

FIG. 19 is a flow chart showing one example of a flow of a firmware update process in the first modified example. Differences from the process shown in FIG. 5 is that the step S19 is changed to the step S19A. The other processes are the same as the processes shown in FIG. 5. Therefore, a description thereof will not be repeated.

In the step S19A, a third warning message is displayed in the display unit 161, and the process proceeds to the step S17. The third warning message is a message for making notification of the update of the firmware with the firmware of the former version in the case where the process specified in the step S15 is executed. When setting a settability state, the user can be informed that the process is to be executed after the firmware of the former version is installed since an error occurs if the process is executed with the firmware of a newer version installed. Further, in the case where the process proceeds to the step S19A, the settability state is set to the enabled state in the next step S17.

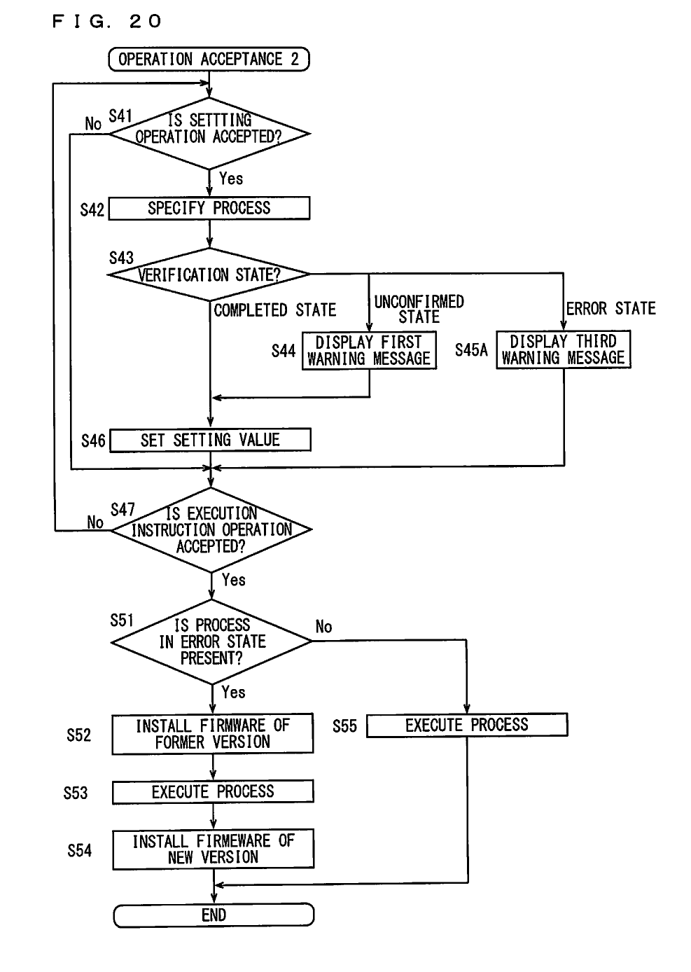

FIG. 20 is a flow chart showing one example of a flow of an operation acceptance process in the first modified example. The operation acceptance process in the first modified example is different from the operation acceptance process shown in FIG. 7 in that the step S43 and the step S45 are changed to the step S43A and the step S45A, and the steps S51 to S55 are added instead of the step S48. The other processes are the same as the processes shown in FIG. 7. Therefore, a description thereof will therefore not be repeated.

In the step S43A, the process branches according to the verification state of the process specified in the step S42. In the firmware update process shown in FIG. 19, the user may set the process, the verification state of which is the unconfirmed state or the error state, in the enabled state. Therefore, the setting operation accepted in the step S41 is the setting operation for the process, the verification state of which is the completed state, the unconfirmed state or the error state. Therefore, in the step S43A, if the verification state is the completed state, the process proceeds to the step S46. If the verification state is the unconfirmed state, the process proceeds to the step S44. If the verification state is the error state, the process proceeds to the step S45A.

In the step S44, the first warning message is displayed in the display unit 161, and the process proceeds to the step S46. The first warning message makes notification that a non-occurrence of an error during execution of the process, the settability state of which is set to the enabled state, has not been confirmed.

In the step S45A, the third warning message is displayed in the display unit 161, and the process proceeds to the step S46. In the case where the process specified in the step S15 is executed, the third warning message is a message for making notification of the update of the firmware with the firmware of the former version.

In the step S46, the CPU 111 sets the setting value for the process specified in the step S42 in accordance with the setting operation accepted in the step 41, and the process proceeds to the step S47. In the case where the process proceeds from the step S44, the setting value is set. Therefore, the user can make settings to allow the execution of the process. However, because the first warning message is displayed in the step S44, the user, when setting a setting value, can be informed of possibility of an occurrence of an error in the case where the process is executed. Further, in the case where the process proceeds from the step S45A, the setting value is set. Therefore, the user can make settings to allow the execution of the process. However, because the third warning message is displayed in the step S45A, the user, when setting a setting value, can be informed of the execution of the process with the firmware of the former version installed.

In the step S47, the CPU 111 determines whether the execution instruction operation of inputting in the operation unit 163 by the user has been accepted. If the execution instruction operation has been accepted, the process proceeds to the step S51. If not, the process returns to the step S41.

In the step S51, the CPU 111 determines whether the process, the verification state of which is the error state, is present among one or more processes executed in accordance with the setting value set in the step S46, the one or more processes being out of the plurality of processes defined by the firmware of the second version installed in the MFP 100. If even one of the processes is in the error state, the process proceeds to the step S52. If not, the process proceeds to the step S55. In the step S55, the CPU 111 executes one or more processes out of the plurality of processes defined by the second firmware installed in the MFP 100 in accordance with the setting value set in the step S46, and the process ends.

In the step S52, the firmware of the former version is installed, and the process proceeds to the step S53. Here, because the firmware of the second version is installed, the CPU 111 installs the firmware of the first version that is installed before installation of the firmware of the second version.

Then, the CPU 111 executes one or more processes out of the plurality of processes defined by the first firmware installed in the MFP 100 in accordance with the setting value set in the step S46 (step S53), and the process proceeds to the step S54. In the step S54, the firmware of the new version is installed, and the process ends. Here, the firmware of the first version is installed in the step S52, so that the firmware of the second version that is newer than the firmware of the first version is installed, and the process ends.

In the first modified example, in the case where an error process, the verification state of which is the error state, is to be executed, the firmware of the former version is installed, and then the process is executed. However, also in the case where an unconfirmed process, the verification state of which is the unconfirmed state, is to be executed, the firmware of the former version may be installed, and then the process may be executed.

In response to reception of the user input operation for allowing the execution of the unverified process, the settability state of which is set to the enabled state, the MFP 100 in the first modified example installs the firmware of the first version, and installs the firmware of the second version after the execution of the unverified process. Therefore, the unverified process can be reliably executed. Further, because the firmware of the second version is installed after the execution of the unverified process, in the case where a user input operation for allowing the execution of a process that is not an unverified process is received, the firmware of the newest version is executed. Thus, the firmware of the newest version possible can be utilized.

In the MFP 100 in one or more embodiments of the present invention, as for a process, the verification state of which is the unverified state, in the case where the process is in the unconfirmed state, the user can set the settability state of the process to the enabled state. However, in the case where the process is in the error state, the user cannot set the settability state of the process to the enabled state. Further, in the first modified example, as for a process, the verification state of which is the unverified state, also in the case where the process is in the error state in addition to the case where the process is in the unconfirmed state, the user can set the settability state of the process to the enabled state.

In the MFP 100 in the second modified example, as for a process, the verification state of which is the unverified state, in the case where the process is in either the unconfirmed state or the error state, the user cannot set the settability state of the process to the enabled state. In this case, the canceling portion 75 and the warning portion 63 are not necessary in the functions shown in FIG. 4.

Further, in the firmware update process shown in FIG. 5, in the case where the process is in the unconfirmed state or the error state in the step S16, the process may return to the step S01.

As described above, the MFP 100 in the second modified example functions as an information processing apparatus, downloads a set of the firmware of the second version and verification state information from the server 200, updates the firmware of the first version with the firmware of the second version, and sets the settability of an unverified process out of the plurality of processes defined by the firmware of the second version to the disabled state. Therefore, when verification of a non-occurrence of an error during execution of a process has not been completed, the process is prevented from being executed by a user's instruction. When verification of a non-occurrence of an error during execution of a process is completed, the process can be executed by a user's instruction. Therefore, the firmware can be installed even when the verification of all of the plurality of processes defined by the firmware of the new version has not been completed, so that the firmware of the new version can be installed as early as possible.

The MFP 100 in one or more embodiments of the present invention installs the firmware of the second version regardless of the verification state information corresponding to the firmware of the second version. In the case where the verification state of a process is the error state, the process being out of the plurality of processes defined by the firmware of the second version, being out of the plurality of processes defined by the firmware of the first version, and having been executed in the past, the MFP 100 in one or more embodiments of the present invention does not install the firmware of the second version.

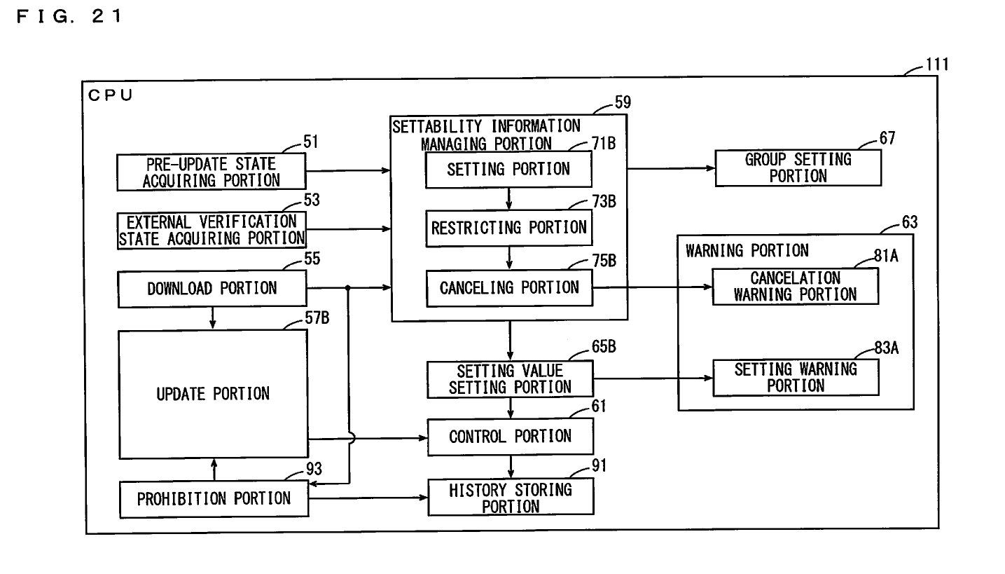

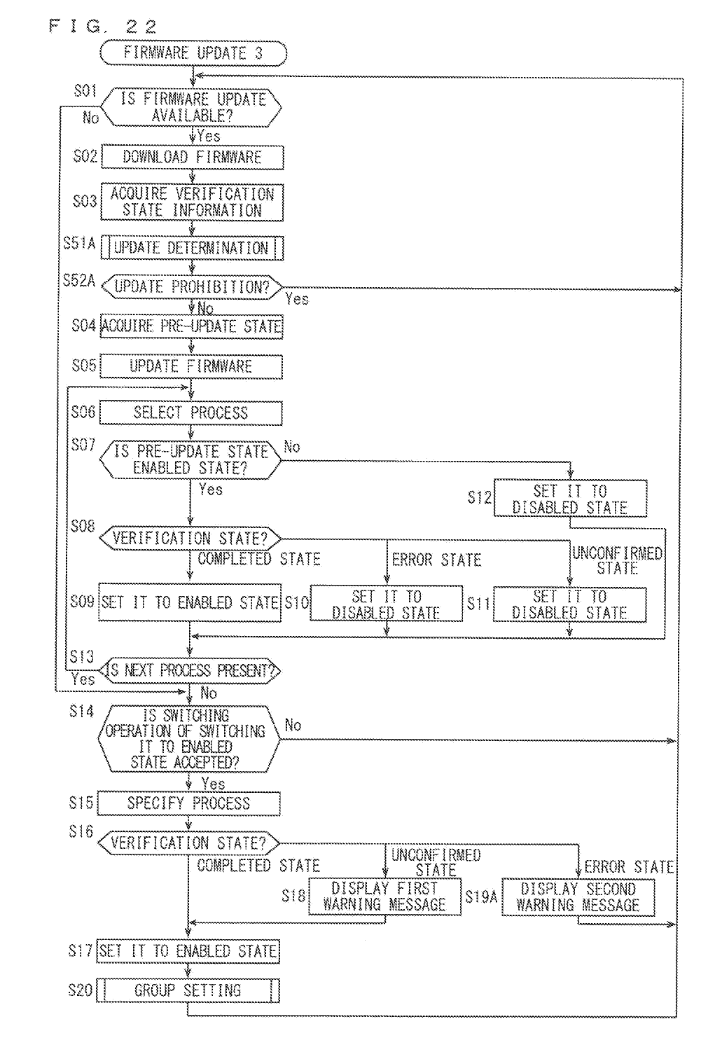

FIG. 21 is a block diagram showing one example of an outline of functions of a CPU of an MFP in one or more embodiments of the present invention. Referring to FIG. 21, differences from the functions shown in FIG. 4 are the update portion 57, the setting value setting portion 65, the setting portion 71, the restricting portion 73, the canceling portion 75, the cancelation warning portion 81 and the setting warning portion 83 are changed to an update portion 57B, a setting value setting portion 65B, a setting portion 71B, a restricting portion 73B, a canceling portion 75B, a cancelation warning portion 81A and a setting warning portion 83A, and a history storing portion 91 and a prohibition portion 93 are added. The other functions are the same as the functions shown in FIG. 4, and the cancelation warning portion 81A and the setting warning portion 83A are the same as the ones shown in FIG. 18. Therefore, a description thereof will not be repeated.

The history storing portion 91 stores the history of processes that have been executed by a control portion 61 in the HDD 115. The history storing portion 91 outputs the history of execution of the processes stored in the HDD 115 to the prohibition portion 93.

The prohibition portion 93 receives the verification state information of the firmware of the second version from the download portion 55, and receives history of the processes from the history storing portion 91. As for the execution process specified by the history of processes, in the case where the verification state information of the execution process indicates the error state, the prohibition portion 93 prohibits installation of the firmware of the second version. Specifically, in the case where prohibiting the installation of the firmware of the second version, the prohibition portion 93 outputs a prohibition signal to the update portion 57B.

In the case where not receiving the prohibition signal from the prohibition portion 93, the update portion 57B updates the firmware of the first version with the firmware of the second version by installing the firmware of the second version from the download portion 55. In the case where receiving the prohibition signal from the prohibition portion 93, the update portion 57B does not install the firmware of the second version from the download portion 55, and does not update the firmware of the first version with the firmware of the second version.

The case where the verification state information of each of the plurality of processes defined by the firmware of the first version is a completed state is described here as an example.

In the case where the second firmware is not installed by the update portion 57B, the firmware of the first version is installed. In this case, if the verification completed process is set in the enabled state by the pre-update state information, the setting portion 71B sets the settability state to the enabled state. If the verification completed process is set to the disabled state by the pre-update state information, the setting portion 71B sets the settability state to the disabled state.

Further, in the case where the second firmware is installed by the update portion 57B, the setting portion 71B sets the settability state of each of the verification completed processes out of the plurality of processes defined by the firmware of the second version to the state that is the same as the state in the pre-update state information. Specifically, if the verification completed process is set in the enabled state by the pre-update state information, the setting portion 71B sets the settability state to the enabled state. If the verification completed process is set in the disabled state by the pre-update state information, the setting portion 71B sets the settability state to the disabled state.

In the case where the second firmware is installed by the update portion 57B, the restricting portion 73B sets the settability state of each of the unverified processes that are set in the unverified state by the verification state information out of the plurality of processes defined by the firmware of the second version to the disabled state. Thus, the settability state of the unverified process is set to the disabled state, so that the user cannot make settings to allow the execution of the unverified process. The restricting portion 73B outputs the process identification information for identifying the unverified process, the settability state of which is set to the disabled state, to the canceling portion 75B.

The canceling portion 75B receives the process identification information of the unverified process, the settability state of which is set to the disabled state by the restricting portion 73B. The unverified state includes the error state where an occurrence of an error is confirmed and the unconfirmed state where an occurrence of an error is not confirmed. As for an unconfirmed process that is set in the unconfirmed state by the verification state information out of the unverified processes specified by the process identification information received from the restricting portion 73B, the canceling portion 75B sets the settability state to the enabled state in accordance with a user operation of inputting in the operation unit 163. Because an occurrence of an error is not confirmed for the unconfirmed process, an error may not occur. Therefore, it is possible to improve the user convenience by enabling the user to use the MFP 100. Further, as for an error process that is set in the error state by the verification state information out of the unverified processes specified by the process identification information received from the restricting portion 73B, even when a user operation of inputting in the operation unit 163 is accepted, the canceling portion 75B does not set the settability state to the enabled state. The occurrence of an error is confirmed for the error process. Therefore, it is possible to prevent an occurrence of an error by disabling the user to make settings to allow the execution of the error process. The canceling portion 75B outputs the process identification information of the unconfirmed process, the settability state of which is set to the enabled state, to the warning portion 63.

As for the unconfirmed process that is set in the unconfirmed state by the verification state information out of the unverified processes specified by the process identification information received from the restricting portion 73B, in the case where the enabled state is set by the pre-update state information, the canceling portion 75B may set the settability state to the enabled state. Because a user operation is not necessary, the work to be done by the user can be simplified. Also in this case, the canceling portion 75B outputs the process identification information of the unconfirmed process, the settability state of which is set to the enabled state, to the warning portion 63.

In the case where the firmware of the second version is not installed by the update portion 57B, and the firmware of the first version is installed, the setting value setting portion 65B receives the settability state for each of the plurality of processes defined by the firmware of the first version from the settability information managing portion 59. The setting value setting portion 65B sets a setting value for each process, the settability of which is set to the enabled state, out of the plurality of processes defined by the firmware of the first version. As for the process, the settability state of which is set to the disabled state, the setting value setting portion 65B does not set a setting value. The setting value setting portion 65B outputs the setting value set for each of the plurality of processes defined by the firmware of the first version to the control portion 61.

In the case where the firmware of the second version is installed by the update portion 57B, the setting value setting portion 65B receives the settability state for each of the plurality of processes defined by the firmware of the second version from the settability information managing portion 59. The setting value setting portion 65B sets a setting value for each process, the settability state of which is set to the enabled state, out of the plurality of processes defined by the firmware of the second version in accordance with a user operation of inputting in the operation unit 163. As for the process, the settability state of which is set to the disabled state, the setting value setting portion 65B does not set a setting value. The setting value setting portion 65B outputs the setting value set for each of the plurality of processes defined by the firmware of the second version to the control portion 61.

In the case where the verification state of the process that is a subject of a user input operation is the unverified state, the setting value setting portion 65B outputs the process identification information of the process that is a subject of the user input operation to the warning portion 63.

FIG. 22 is a flow chart showing one example of a flow of a firmware update process in one or more embodiments of the present invention. Referring to FIG. 22, a difference from the firmware update process in one or more embodiments of the present invention shown in FIG. 5 is that the step S51A and the step S52A are added between the step S03 and the step S04. The other processes are the same as the process shown in FIG. 5. Therefore, a description thereof will not be repeated.

In the step S51A, the CPU 111 executes an update determination process, and the process proceeds to the step S52A. In the step S52A, as a result of execution of the update determination process, the CPU 111 determines whether the determination is made that the firmware update is prohibited. If the determination is made that the firmware update is prohibited, the process returns to the step S01. If not, the process proceeds to the step S04.

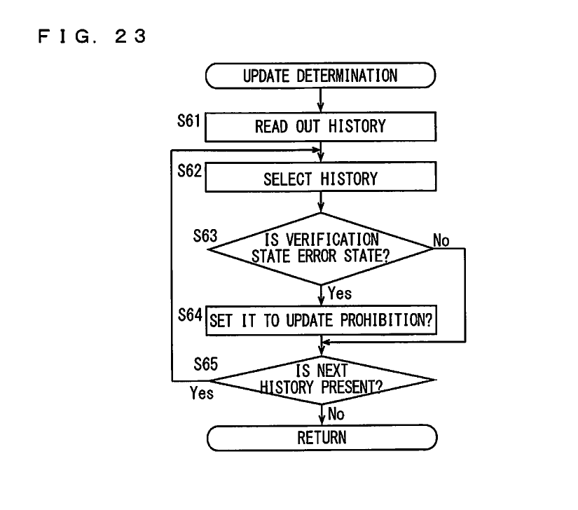

FIG. 23 is a flow chart showing one example of a flow of the update determination process. The update determination process is executed in the step S51A of FIG. 22. Referring to FIG. 23, the CPU 111 reads out the history stored in the HDD 115 (step S61). The history shows the processes that have been executed by the MFP 100 in the past, and includes the process identification information for identifying the processes that have been executed in the past. Then, the CPU 111 selects one history data piece from among the read history data pieces (step S62). In the next step S63, the CPU 111 determines whether the verification state corresponding to the process specified by the process identification information included in the selected history data piece indicates an error state. If the error state is indicated, the process proceeds to the step S64. If not, the process proceeds to the step S65. In the step S64, the CPU 111 makes settings to prohibit the firmware update, and the process proceeds to the step S65.

In the step S65, the CPU 111 determines whether there is a history data piece that is not selected in the step S62 out of the history data pieces read in the step S61. If the unselected history data piece is present, the process returns to the step S62. If not, the process returns to the firmware update process.

In the case where the verification state is the error state for at least one of the processes that have been executed in the past, the settings are made to prohibit the firmware update. Thus, the CPU 111 does not install the firmware that has been confirmed to cause an error in a process that is highly likely to be executed in the MFP 100. Therefore, the convenience can be maintained.

In the CPU 111 included in the MFP 100 in one or more embodiments of the present invention, the same process as the operation acceptance process shown in FIG. 7 is executed.

The MFP 100 in one or more embodiments of the present invention downloads a set of the firmware of the second version and the verification state information from the server 200. In the case where there is a process, the verification state information of which indicates an error state, the process being an execution process specified by the history of processes that have been executed in the past and being out of the plurality of processes defined by the firmware of the second version, installation of the firmware of the second version is prohibited. Thus, in the case where the verification state information indicates an error state for an execution process that has been executed in the past, the firmware of the second version is not installed. In the case where the verification state information does not indicate an error state for an execution process that has been executed in the past, the firmware of the second version is installed. Therefore, the firmware of the new version can be installed according to the usage history of the user.

In the MFP 100 in one or more embodiments of the present invention, the verification state of the process, that is one of the plurality of processes defined by the firmware of the second version, is one of the plurality of processes defined by the firmware of the first version and has never been executed in the past, may be the error state. Therefore, in the MFP 100 in one or more embodiments of the present invention, as for the process, the verification state of which is the unverified state, in the case where the verification state is the unconfirmed state, the user can set the settability state to the enabled state. However, in the case where the verification state is the error state, the user cannot set the settability state to the enabled state. In the third modified example, as for the process, the verification state of which is the unverified state, also in the case where the verification state is the error state in addition to the case where the verification state is the unconfirmed state, the user can set the settability state to the enabled state.

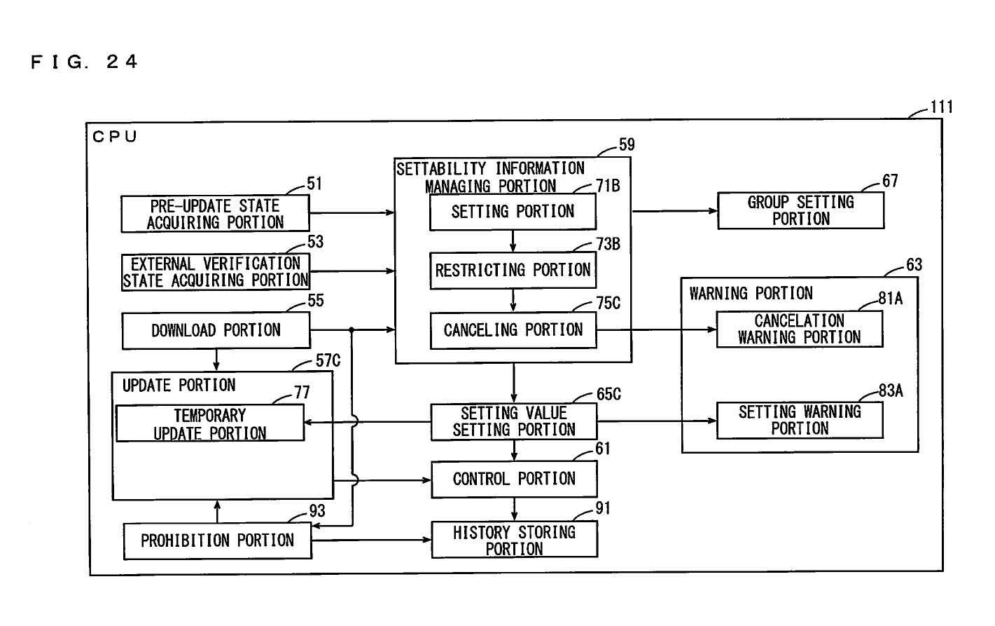

FIG. 24 is a block diagram showing one example of an outline of functions of the CPU of the MFP in the third modified example. Referring to FIG. 24, differences from the functions shown in FIG. 21 are that the update portion 57B, the canceling portion 75B and the setting value setting portion 65B are changed to an update portion 57C, a canceling portion 75C and a setting value setting portion 65C. The other functions are the same as the functions shown in FIG. 21. Therefore, a description thereof will not be repeated. The update portion 57C includes a temporary update portion 77.

The canceling portion 75C receives the process identification information of the unverified process, the settability state of which is set to the disabled state by the restricting portion 73B. The unverified state includes the error state where an occurrence of an error is confirmed and the unconfirmed state where an occurrence of an error is not confirmed. As for an unverified process specified by the process identification information received from the restricting portion 73B, the canceling portion 75C sets the settability state to the enabled state in accordance with the user operation of inputting in the operation unit 163. In the case where the unverified process, the settability state of which is set to the enabled state, is the unconfirmed process indicating the unconfirmed state, the canceling portion 75C outputs the process identification information of the unconfirmed process to the warning portion 63.

As for the unverified process specified by the process identification information received from the restricting portion 73B, in the case where the settability state is set to the enabled state by the pre-update state information, the canceling portion 75C may set the settability state to the enabled state. Because a user operation is not necessary, the work to be done by the user can be simplified. Also, in the case where the unverified process, the settability state of which is set to the enabled state, is the unconfirmed process indicating the unconfirmed state, the canceling portion 75C outputs the process identification information of the unconfirmed process to the warning portion 63.

The setting value setting portion 65C receives the settability state for each of the plurality of processes defined by the firmware of the second version from the settability information managing portion 59. The setting value setting portion 65C sets a setting value for each process, the settability state of which is set to the enabled state, out of the plurality of processes defined by the firmware of the second version in accordance with the user operation of inputting in the operation unit 163. The setting value setting portion 65C does not set a setting value for the process, the settability state of which is set to the disabled state. The setting value setting portion 65C outputs a setting value set for each of the plurality of processes defined by the firmware of the second version to the control portion 61.

In the case where the verification state of the process that is a subject of a user input operation is the unverified state, the setting value setting portion 65C outputs the process identification information of the unverified process that is a subject of the user operation to the setting warning portion 83A. The unverified state includes the unconfirmed state and the error state. Further, in the case where the verification state of the process that is a subject of the user input operation is the error state, the setting value setting portion 65C outputs an update instruction to the temporary update portion 77.

With the firmware of the second version installed, the temporary update portion 77 updates the firmware by installing the firmware of the first version in response to reception of the update instruction from the setting value setting portion 65C. When the control portion 61 executes the process in accordance with the setting value set by the setting value setting portion 65C after installation of the firmware of the second version, and the process ends, the temporary update portion 77 updates the firmware by installing the firmware of the second version.

Because an occurrence of an error has not been confirmed for the unconfirmed process, an error may not occur. Therefore, it is possible to improve the user convenience by enabling the user to use the device. Further, because it is confirmed that an error occurs during execution of the error process, the occurrence of an error during execution of the process when the firmware of the second version is installed is informed in advance. Therefore, in the case where the user makes settings to allow the execution of the error process, the firmware of the first version is installed. Thus, an occurrence of an error can be prevented. Further, because the firmware of the second version is installed after the execution of the process, the firmware of the newest version can be installed in the MFP 100.

In the CPU 111 included in the MFP 100 in the third modified example, the process that is the same as the firmware update process shown in FIG. 22 is executed, and the process that is the same as the operation acceptance process shown in FIG. 20 is executed.

While the MFP 100 is described as one example of the information processing apparatus in which the firmware is installed in the above-mentioned embodiments, it is needless to say that the present invention can be specified as the firmware update method for allowing the MFP 100 to execute the firmware update process shown in FIG. 5, 19 or 22 and the operation acceptance process shown in FIG. 7 or 20, and as the firmware update program for allowing the CPU 111 of the MFP 100 to perform the firmware update method.

Although embodiments of the present invention have been described and illustrated in detail, the disclosed embodiments are made for purpose of illustration and example only and not limitation. The scope of the present invention should be interpreted by terms of the appended claims.

What is claimed is:

1. An information processing apparatus comprising:
a hardware processor that:
executes an installed firmware of a first version;
acquires a set of firmware of a second version that is newer than the first version and verification state information that indicates progress of verification of each of a plurality of processes defined by the firmware of the second version from a server; and
updates the firmware of the first version with the firmware of the second version, wherein
the verification state information indicates progress of verification that an error does not occur during execution of each of the plurality of processes, and indicates either a completed state where the verification of a non-occurrence of an error is completed or an unverified state where the verification of the non-occurrence of an error is not completed,
the hardware processor further sets a settability state of an unverified process, out of the plurality of processes, to a disabled state where a user cannot make settings to allow execution of the unverified process, and
the verification state information of the unverified process indicates the unverified state.

2. The information processing apparatus according to claim 1, wherein
the unverified state comprises an error state where an occurrence of the error is confirmed, and
the hardware processor further:
stores history of execution processes that have been executed by the hardware processor, and
prohibits installation of the firmware of the second version when the verification state information that makes a set with the firmware of the second version indicates the error state of an execution process specified by the history.

3. The information processing apparatus according to claim 1, wherein
the hardware processor further changes the settability state of the unverified process from the disabled state to an enabled state where the user can make settings to allow execution of the unverified process.

4. The information processing apparatus according to claim 3, wherein
when the settability state of the unverified state is set to the enabled state, the hardware processor further notifies the user of a warning message that indicates that the verification is not completed.

5. The information processing apparatus according to claim 3, wherein
in response to setting of execution of the unverified process that the settability state is set to the enabled state, the hardware processor, in accordance with a user input operation, further notifies the user of a warning message that indicates that the verification is not completed.

6. The information processing apparatus according to claim 3, wherein
in response to a user input operation for making settings to allow execution of the unverified process that the settability state is set to the enabled state, the hardware processor further installs the firmware of the first version and installs the firmware of the second version after the unverified process is executed.

7. The information processing apparatus according to claim 3, wherein
when the settability state of the unverified process to be executed with the firmware of the first version installed is set to the enabled state, the hardware processor sets the settability state of the unverified process to be executed with the firmware of the second version installed to the enabled state.

8. The information processing apparatus according to claim 1, wherein
the hardware processor further:
acquires the settability state of each of a plurality of executable processes with firmware, corresponding verification state information of which does not include an unverified state, installed as a pre-update state, and
sets the settability state of a verification completed process that is set in the completed state out of the plurality of processes defined by the firmware of the second version to the settability state defined by the pre-update state.

9. The information processing apparatus according to claim 1, wherein
in response to installation of the firmware of the second version, the hardware processor further allows another information processing apparatus to install the firmware of the second version, and allows the other information processing apparatus to set the settability state of an unverified process that the verification state information indicates the unverified state, out of a plurality of executable processes.

10. The information processing apparatus according to claim 1, wherein
the hardware processor further acquires external verification state information that indicates a verified state of a service provided by an external server,
the external verification state information indicates progress of verification of the non-occurrence of the error, and indicates the completed state where the verification is completed and the unverified state where the verification is not completed, and
the hardware processor sets an unverified service that the external verification state information indicates the unverified state, based on the external verification state information to the disabled state where setting of allowing execution of the unverified service by the external server cannot be made.

11. The information processing apparatus according to claim 1, wherein
in response to update of the firmware of the first version with the firmware of the second version, the hardware processor further transmits the firmware of the second version and the settability state to allow another information processing apparatus to install the firmware of the second version.

12. The information processing apparatus according to claim 1, wherein
the hardware processor further determines priority order of verification for unverified processes that are set in the unverified state by verification state information out of the plurality of processes defined by the firmware of the second version.

13. The information processing apparatus according to claim 12, wherein
the hardware processor further gives higher priority order to an execution process that has been executed.

14. The information processing apparatus according to claim 12, wherein
the hardware processor further gives higher priority order to an unverified process that the settability state is set to the enabled state.

15. An information processing apparatus comprising:
a hardware processor that:
executes an installed firmware of a first version;
stores history of execution of execution processes;
acquires a set of firmware of a second version that is newer than the first version and verification state information that indicates progress of verification for each of a plurality of processes defined by the firmware of the second version from a server; and
installs the firmware of the second version to update the firmware of the first version with the firmware of the second version, wherein
the verification state information indicates progress of verification that an error does not occur during execution of each of the plurality of processes, and indicates either a completed state where the verification is completed or an unverified state where the verification is not completed,
the unverified state comprises an error state where an occurrence of the error is confirmed, and the hardware processor further prohibits installation of the firmware of the second version when the verification state information that makes a set with the firmware of the second version indicates the error state for an execution process specified by the history.

16. The information processing apparatus according to claim 15, wherein
the unverified state comprises an unconfirmed state where the occurrence of the error is not confirmed, and
the hardware processor, after the firmware of the second version is installed, further sets a settability state of an unverified process, out of the plurality of processes, to a disabled state where a user cannot make settings to allow execution of the unverified process based on the verification state information, and
the verification state information of the unverified process indicates the unconfirmed state.

17. The information processing apparatus according to claim 15, wherein
the hardware processor further:
acquires a settability state of each of a plurality of executable processes with firmware, corresponding verification state information of which does not include an unverified state, installed as a pre-update state, and
sets the settability state of a verification completed process that is set in a completed state out of a plurality of processes defined by the firmware of the second version to a settability state defined by the pre-update state.

18. The information processing apparatus according to claim 15, wherein
in response to installation of the firmware of the second version, the hardware processor further allows another information processing apparatus to install the firmware of the second version, and allows the other information processing apparatus to set the settability state of an unverified process that the verification state information indicates the unverified state, out of a plurality of executable processes.

19. The information processing apparatus according to claim 15, wherein
the hardware processor further acquires external verification state information that indicates a verified state of a service provided by an external server,
the external verification state information indicates progress of verification of a non-occurrence of the error, and includes a completed state where the verification is completed and an unverified state where the verification is not completed, and
an unverified service that the external verification state information indicates the unverified state, is set based on the external verification state information in the disabled state where setting of allowing execution of the unverified service by the external server cannot be made.

20. The information processing apparatus according to claim 15, wherein
in response to update of the firmware of the first version with the firmware of the second version, the hardware processor further transmits the firmware of the second version and the settability state to allow another information processing apparatus to install the firmware of the second version.

21. The information processing apparatus according to claim 15, wherein
the hardware processor further determines priority order of verification for unverified processes that are set in the unverified state by verification state information out of the plurality of processes defined by the firmware of the second version.

22. A firmware update method comprising:
executing an installed firmware of a first version;
acquiring a set of firmware of a second version that is newer than the first version and verification state information that indicates progress of verification of each of a plurality of processes defined by the firmware of the second version from a server; and
updating the firmware of the first version with the firmware of the second version, wherein
the verification state information indicates progress of verification that an error does not occur during execution of each of the plurality of processes, and indicates either a completed state where the verification of a non-occurrence of the error is completed or an unverified state where the verification of the non-occurrence of the error is not completed,
the firmware update method further comprises setting a settability state of an unverified process, out of the plurality of processes, to a disabled state where a user cannot make settings to allow execution of the unverified process, and
the verification state information of the unverified process indicates the unverified state.

23. A firmware update method comprising:
executing an installed firmware of a first version;
storing history of execution of execution processes;
acquiring a set of firmware of a second version that is newer than the first version and verification state information that indicates progress of verification for each of a plurality of processes defined by the firmware of the second version from a server; and
installing the firmware of the second version in order to update the firmware of the first version with the firmware of the second version, wherein
the verification state information indicates progress of verification that an error does not occur during execution of each of the plurality of processes, and indicates either a completed state where the verification is completed or an unverified state where the verification is not completed,
the unverified state comprises an error state where an occurrence of an error is confirmed, and
the firmware update method further comprises prohibiting installation of the firmware of the second version when the verification state information that makes a set with the firmware of the second version indicates the error state for an execution process specified by the history.
